(19) United States
(12) Patent Application Publication
(10) Pub. No.: US 2013/0002487 A1
(43) Pub. Date: Jan. 3, 2013

(54) CONTROL METHOD OF RADIO COMMUNICATION SYSTEM, RADIO COMMUNICATION SYSTEM, AND RADIO COMMUNICATION APPARATUS

(76) Inventors: Kenichi Hosoya, Tokyo (JP); Kenichi Maruhashi, Tokyo (JP); Naoyuki Orihashi, Tokyo (JP)

(21) Appl. No.: 13/635,251

(22) PCT Filed: Dec. 28, 2010
(86) PCT No.: PCT/JP2010/007598

§ 371 Date: Sep. 14, 2012

(30) Foreign Application Priority Data
Mar. 18, 2010 (JP) 2010-062568

(51) Int. Cl. H04B 7/10

(52) U.S. Cl. 342/372

(57) ABSTRACT

A communication quality test is performed for combinations between antenna setting candidates of a transmitting antenna of a first communication device (1) and a receiving antenna of a second communication device (2), and a list in which antenna-setting pairs are arranged according to the communication quality is created. If there are two or more antenna-setting pairs having the same antenna setting for one of the transmitting and receiving antennas, it is determined that an antenna-setting pair(s) ranked in a second or lower place is caused by a side-lobe and thus the list is updated by deleting that antenna-setting pair(s) from the list or lowering its priority rank in the list. The above-described steps are performed for a receiving antenna of the first communication device (1) and a transmitting antenna of the second communication device (2). An antenna-setting pair is successively selected from the updated antenna-setting-pair list and communication is performed.

### TECHNICAL FIELD

The present invention relates to a system that performs radio communication by adaptively controlling radio beams, and its control method.

### BACKGROUND ART

In recent years, use of radio devices using wideband millimeter waves (30 GHz to 300 GHz) has become increasingly widespread. The millimeter-wave radio technology has been expected to be used especially for high-rate radio data communication in the order of gigabit such as radio transmission of high-resolution images (for example, see Non-patent literatures 1, 2 and 3).

However, millimeter waves having high frequencies have a high rectilinear propagation property, and therefore they cause a problem in cases where radio transmission is to be implemented indoors. In addition to the high rectilinear propagation property, millimeter waves are significantly attenuated by a human body or a similar object. Therefore, if a person stands between the transmitter and the receiver in a room or a similar circumstance, no unobstructed view can be obtained, thus making the transmission very difficult (shadowing problem). This problem results from the fact that the propagation environment has been changed because of the increase in the rectilinear propagation property of the radio waves, which results from the increase in the frequency. Therefore, this problem is not limited to the millimeter waveband (30 GHz and above). Although it is impossible to clearly specify the transition frequency at which the propagation environment of the radio waves changes, it has been believed to be around 10 GHz. Note that according to recommendations of the International Telecommunications Union (“Propagation data and prediction methods for the planning of indoor radio communication systems and radio local area networks in the frequency range 900 MHz to 100 GHz,” ITU-R, P.1238-3, April, 2003), a power loss coefficient, which indicates the attenuation amount of a radio wave with respect to the propagation distance, is 22 for 60 GHz in an office, while it is 28 to 32 for 0.9 to 5.2 GHz. Considering that it is 20 in the case of free-space loss, the effects of scattering, diffraction, and the like are considered to be small in higher frequencies such as 60 GHz.

To solve the problem described above, Patent literature 2, for example, discloses a system in which a plurality of transmission paths are provided by installing a plurality of receiving units in the receiver, so that when one of the transmission paths between the transmitter and the receiving units is shielded, the transmission is carried out by another transmission path(s).

Further, as another method for solving the problem, Patent literature 3 discloses a contrivance to secure a plurality of transmission paths by installing reflectors on the walls and ceilings.

The method disclosed in Patent literature 2 cannot carry out transmission when shielding occurs in the vicinity of the transmitter or when all of the installed receiving units are shielded. Meanwhile, the method disclosed in Patent literature 3 requires users to give particular consideration to the configuration. For example, the reflectors need to be installed with consideration given to the positions of the transmitter and the receiver.

However, recent studies on propagation properties of millimeter waves have found out that reflected waves could be utilized without intentionally installing reflectors. FIG. 31 shows a configuration of a system using a wide-angle antenna, and FIG. 32 shows an example of a delay profile of a system using a wide-angle antenna like the one shown in FIG. 31 when the system is used indoors. In the system using the wide-angle antennas shown in FIG. 31, the received power of the dominant wave, which is arrives faster than any other waves, is larger than that of any other waves as shown in FIG. 32. After that, although delayed waves such as the second and third waves arrive, their received power is smaller. These second and third waves are waves reflected from the ceiling and the walls. This situation is remarkably different from the propagation environment of radio waves having a lower rectilinear propagation property, such as a 2.4 GHz band used in wireless LANs (Local Area Networks). In 2.4 GHz band, it is very difficult to clearly separate waves in their directions-of-Arrival (DoAs) because of the effects of diffraction and multiple reflections. In contrast to this, in the millimeter waves having a high rectilinear propagation property, although radio waves are relatively clearly distinguished in their DoAs, the number of delayed waves is limited and their received-signal levels are small.

Therefore, when the direct wave is blocked, it is necessary to ensure a sufficient received-signal level by pointing a narrow beam having a high directive gain to a DoA of a reflected wave as shown in FIGS. 30A and 30B in order to continue the transmission by using the reflected wave. However, in order to free users from the need to give particular consideration to the configuration such as the relative positions of the transmitter and receiver, a beam forming technique capable of dynamically controlling a narrow beam is indispensable.

To implement beam forming, it is necessary to use an antenna having function of controlling its directivity. One of the typical antennas for such use is a phased array antenna. For millimeter waves having a short wavelength (e.g., 5 mm in the case of a frequency of 60 GHz), the phased array antenna can be implemented in a small area, and phase shifter arrays and oscillator arrays for use in those antenna arrays have been developed (for example, see Non-patent literatures 3 and 4). In addition to the phased array antenna, a sector-selectable antenna and a mechanically-direction-adjustable antenna may be also used to implement the antenna directivity control.

Further, as a technique for a different purpose from the beam forming using an antenna array, a direction-of-arrival (DoA) estimation technique has been known. The DoA estimation techniques are used in, for example, radars, sonar, and propagation environment measurements, and used for estimating the DoAs and the power of radio waves to be received at antenna arrays with high accuracy. When a DoA estimation technique is used in propagation environment measurement with an installed radio wave source, an omni (nondirectional) antenna is often used as the radio wave source. For example, Non-patent literature 6 shows an example of such a technique.

### CITATION LIST

### Patent Literature

Patent literature 1: International Patent Publication WO2008/090836
Patent literature 2: Japanese Patent Application Publication No. 2006-245986
Patent literature 3: Japanese Patent Application Publication No. 2000-165959
Patent literature 4: United States Patent Application Publication No. 2007/0205943

### Non Patent Literature

Non-patent literature 1: K. Maruhashi et al., “60-GHz-band LTCC Module Technology for Wireless Gigabit Transceiver Applications”, IEEE International Workshop on Radio-Frequency Integration Technology, Digest, pp. 131-134, December, 2005.
Non-patent literature 2: K. Ohata et al., “1.25 Gbps Wireless Gigabit Ethernet Link at 60 GHz-Band”, IEEE MTT-S International Microwave Symposium, Digest, pp. 373-376, June 2003.
Non-patent literature 3: J. F. Buckwalter et al., “An Integrated Subharmonic Coupled-Oscillator Scheme for a 60-GHz Phased-Array Transmitter”, IEEE Transactions on Microwave Theory and Techniques, Vol. 12, pp. 4271-4280, December 2006.
Non-patent literature 4: S. Alausi et al., “A 60 GHz Phased Array in CMOS”, IEEE 2006 Custom Integrated Circuits Conference, Digest, pp. 393-396, San Jose, September 2006.
Non-patent literature 5: I. Lakkis et al., “IEEE P802.15 Working Group for Wireless Personal Area Networks (WPANS): TG3c Call for Proposals”, 15-08-0355-00-003c, May, 2008.
Non-patent literature 6: K. Sato et al., “Channel model for millimeter wave WPAN”, The 18th Annual IEEE International Symposium on Personal, Indoor and Mobile Radio communications (PIMRC'07), 2007.

### SUMMARY OF INVENTION

### Technical Problem

In indoor millimeter wave systems, when the direct wave is blocked and the radio transmission is to be continued by using reflected waves, the following problem arises.

When the wave (direct wave, reflected wave) that is actually used is switched, it is desirable to minimize the period during which the transmission is disconnected. Such minimization of the transmission-disconnected time becomes especially an important requirement, for example, in the transmission of non-compressed images that requires a real-time capability. Meanwhile, when a reflected wave is used, it is necessary to increase the directive gain of the antenna and thereby to increase the reception strength by narrowing the antenna beam width.

However, the number of directions (steps) in which the search needs to be performed increases as the beam width becomes narrower. Therefore, the time necessary to search the beam directions and thereby set an optimal beam direction becomes longer, and therefore transmission-disconnected time also becomes longer. Accordingly, it has been desired to develop a beam direction setting method that can shorten the transmission-disconnected time even in such situations. It should be noted that the use of a device capable of temporally storing data is impractical because a huge buffer memory is required when the transmission-disconnected time becomes longer.

Characteristics of propagation paths between two communication devices are expressed by a channel response matrix. It has been known that if this channel response matrix is determined, the optimal combination of the antenna settings (hereinafter called “antenna-setting pair”) of a transceiver can be obtained by using SVD (Singular-Value Decomposition). However on the other hand, since SVD is complex and requires a long processing time, it is very difficult to implement SVD, for example, in a non-compressed image transmission apparatus that requires a high-rate processing capability.

Accordingly, Patent literature 4, for example, discloses a method for obtaining an optimal AWV (Array Weight Vector) with which the signal strength is maximized by adding a unitary matrix (e.g., Hadamard matrix) as phases of the antenna array and repeating the training of the antenna array of the transmitter and the training of the antenna array of the receiver. Although this method can reduce the processing time in comparison to SVD, it still requires a certain time to obtain the optimal AWV combination because the switching between the transmission and the reception needs to be repeatedly carried out.

Meanwhile, Non-patent literature 5 discloses a technique to optimize a transmitting/receiving beam direction (antenna setting) by gradually increasing the beam resolution. However, this technique also requires measuring communication quality for a large number of combinations of the transmitting/receiving beam directions (antenna settings) while repeatedly carrying out the switching between the transmission and the reception, and thereby requiring a huge amount of time to obtain an optimal beam combination.

Further, this literature also brings up an idea called “quasi-omni (quasi-nondirectional) pattern” as a beam having the lowest resolution. This quasi-omni pattern means a pattern having a constant antenna gain over a very wide angle in the space around the transceiver, though it is not a complete omni (nondirectional) pattern. Since it is often very difficult to obtain a complete omni pattern in antenna arrays, this quasi-omni pattern is often used as a substitute in such cases. Further, in the millimeter waveband, there are cases where it is very difficult to obtain a good quasi-omni pattern. Note that the “good quasi-omni pattern” means an emission pattern having a sufficiently small antenna gain variation over a wide or desired angle range.

In general, when a link is to be established at the initial stage, it would be acceptable if the acquisition of an optimal antenna setting requires a long time. However, in a case where a link needs to be re-established due to disconnection of the transmission on the previously-established link, a fast search for another optimal antenna-setting pair is required. Further, in the case of multipoint communication, a faster search for an optimal antenna-setting pair is also required because it requires re-establishment of a plurality of links.

Accordingly, it is effective to use such a method includes: obtaining and storing, in advance in a training performed for establishing the initial link, a plurality of antenna-setting pairs corresponding to a plurality of propagation paths available for the communication; when the communication is disconnected or the communication quality is deteriorated due to a shielding obstacle or the like, selecting a new antenna-setting pair from the stored reserve antenna-setting pairs; and resuming the communication. In this way, it is possible to reduce the communication disconnection time. For example, the inventors of the present application have proposed, in Japanese Patent Application filed in the past (Japanese Patent Application No. 2008-240156 filed on Sep. 19, 2008), a control method of a radio communication system capable of obtaining and storing antenna-setting pairs corresponding to a plurality of propagation paths available for communication as explained above at high speed with high accuracy.

Further, the inventors of the present application have found out that when antenna-setting pairs corresponding to a plurality of propagation paths available for communication are obtained and stored in advance by carrying out trainings, the side-lobe of the antenna could become a problem depending on the propagation environment and/or the antenna characteristics. The inventors of the present application have also proposed, in Japanese Patent Application filed in the past (Japanese Patent Application No. 2008-282697 filed on Nov. 4, 2008), a control method of a radio communication system equipped with means for solving this problem. Although this method is effective for solving two problems that could be induced by a side-lobe (difficulty in obtaining some of the antenna-setting pairs and emergence of an antenna-setting pair(s) caused by a side-lobe), there are cases where only the latter one causes a substantial problem depending on the propagation environment and/or the antenna characteristics. In such cases, it is effective to adopt a method that is effective only for the latter problem but is simpler and speedier. Alternatively, even in the cases where both of the two problems exist, it is conceivable to cope with only the latter problem to put importance on the processing speed.

The present invention has been made in view of the above-described problems, and an object thereof is to avoid, when antenna-setting pairs corresponding to a plurality of propagation paths available for communication are obtained and stored in advance by carrying out trainings in order to perform radio communication with beam-forming, one of the adverse effects caused by a side-lobe of the antenna (emergence of an antenna setting pair(s) caused by a side-lobe) by using a simple method. Note that the emergence of an antenna-setting pair(s) caused by a side-lobe, which is a problem to be solved by the present invention, is explained in detail in the exemplary embodiment section.

### Solution to Problem

A method according to a first aspect of the present invention is a control method of a radio communication system including first and second communication devices. The first communication device is configured to control a transmission beam direction of a first transmitting antenna by changing a transmitting-antenna setting and to control a reception beam direction of a first receiving antenna by changing a receiving-antenna setting. Further, the second communication device is configured to control a transmission beam direction of a second transmitting antenna by changing a transmitting-antenna setting and to control a reception beam direction of a second receiving antenna by changing a receiving-antenna setting. The method according to this aspect includes the following steps (a) to (f);

(a) transmitting a training signal from the first transmitting antenna and receiving the training signal by the second receiving antenna while changing antenna settings of the first transmitting antenna and the second receiving antenna for each of all or at least a part of combinations of the antenna settings of the first transmitting antenna and the second receiving antenna;

(b) obtaining a data string describing a relation of communication qualities of the second receiving antenna for each of all or at least a part of the combinations of the antenna settings of the first transmitting antenna and the second receiving antenna based on reception results of the training signal obtained in the step (a);

(c) arranging, in the data string, the combinations of the antenna settings in descending order of communication quality;

(d) updating, in the arranged data string, the data string in regard to combinations of antenna settings having the same antenna setting for one of the transmitting and receiving antennas;

(e) obtaining a similar data string by performing the same steps as the steps (a) to (d), which were performed by using the first transmitting antenna and the second receiving antenna, for a combination of the second transmitting antenna and the first receiving antenna; and

(f) using, for communication between the first and second communication devices, the combinations of the first-transmitting-antenna setting and the second-receiving-antenna setting and the combinations of the first-receiving-antenna setting and the second-transmitting-antenna setting described in the data strings obtained in the steps (d) and (e), or at least one of them.

A second aspect of the present invention relates to a radio communication system including first and second communication devices. The first communication device is configured to transmit a radio signal from a first transmitting antenna and to receive a radio signal by a first receiving antenna. The second communication device is configured to transmit a radio signal from a second transmitting antenna and to receive a radio signal by a second receiving antenna. Further, the first and second communication devices are configured to perform a process of determining a transmitting and receiving-antenna setting candidate used for radio communication in a cooperative manner. The determination process includes the following steps (a) to (f):

(a) transmitting a training signal from the first transmitting antenna and receiving the training signal by the second receiving antenna while changing antenna settings of the first transmitting antenna and the second receiving antenna for each of all or at least a part of combinations of the antenna settings of the first transmitting antenna and the second receiving antenna;

(b) obtaining a data string describing a relation of communication qualities of the second receiving antenna for each of all or at least a part of the combinations of the antenna settings of the first transmitting antenna and the second receiving antenna based on reception results of the training signal obtained in the step (a);

(c) arranging, in the data string, the combinations of the antenna settings in descending order of communication quality;

(d) updating, in the arranged data string, the data string in regard to combinations of antenna settings having the same antenna setting for one of the transmitting and receiving antennas;

(e) obtaining a similar data string by performing the same operations as the steps (a) to (d), which were performed by using the first transmitting antenna and the second receiving antenna, for a combination of the second transmitting antenna and the first receiving antenna; and

(f) using, for communication between the first and second communication devices, the combinations of the first-transmitting-antenna setting and the second-receiving-antenna setting and the combinations of the first-receiving-antenna setting and the second-transmitting-antenna setting described in the data strings obtained in the steps (d) and (e), or at least one of them.

A third aspect of the present invention relates to a radio communication apparatus that performs radio communication with a corresponding device. The radio communication apparatus includes a transmitting-antenna setting control unit, a receiving-antenna setting control unit, and a processing unit. The transmitting-antenna setting control unit controls a transmission beam direction of a first transmitting antenna by changing a transmitting-antenna setting. The receiving-antenna setting control unit controls a reception beam direction of a first receiving antenna by changing a receiving-antenna setting. The processing unit performs a process of determining priority order of combinations of antenna settings of the first transmitting antenna and a second receiving antenna of the corresponding device, and a combination of antenna settings of the first receiving antenna and the second transmitting antenna of the corresponding device in a cooperative manner with the corresponding device. The determination process includes the following steps (a) to (e):

(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;

(b) obtaining communication qualities of the second receiving antenna for the at least a part of combinations based on reception results of the training signal obtained in the step (a);

(c) determining priority order among combinations included in the at least a part of combinations in such a manner that a priority rank of a combination of antenna settings for which the communication quality is good becomes relatively high, and a priority rank of a combination for which the communication quality is ranked in a second or lower place among combinations of antenna settings having the same antenna setting for one of the first transmitting antenna and second receiving antenna becomes relatively low;

(d) obtaining similar priority order by performing the same steps as the steps (a) to (c), which were performed by using the first transmitting antenna and the second receiving antenna, for at least a part of possible combinations of antenna settings of the second transmitting antenna and the first receiving antenna; and

(e) determining a combination of antenna settings used for communication between the first and second communication devices based on the priority orders obtained in the steps (c) and (d).

### Advantageous Effects of Invention

According to each of the above-described exemplary embodiments of the present invention, it is possible to avoid, when antenna-setting pairs corresponding to a plurality of propagation paths available for communication are obtained and stored in advance by carrying out trainings in order to perform radio communication with beam-forming, one of the adverse effects caused by a side-lobe of the antenna (emergence of an antenna-setting pair(s) caused by a side-lobe) by using a simple method.

### BRIEF DESCRIPTION OF DRAWINGS

FIG. 1 is a sequence diagram showing an operation of a communication device before radio communication is performed in a radio control procedure according to a first exemplary embodiment of the present invention;

FIG. 2 shows an example of a device configuration used for beam forming, to which the present invention is applicable;

FIG. 3 is a schematic diagram for explaining a radio communication system including two communication devices;

FIG. 4 shows an example of a device configuration used for beam forming, to which the present invention is applicable;

FIG. 5 shows transitions in a radio control procedure according to a first exemplary embodiment of the present invention;

FIG. 6 shows transitions in a radio control procedure according to a second exemplary embodiment of the present invention;

FIG. 7 shows transitions in a radio control procedure according to a third exemplary embodiment of the present invention;

FIG. 8 is a plane view showing an example of a propagation environment to which the present invention is applied;

FIG. 9 is a plane view showing an example of a propagation environment to which the present invention is applied;

FIG. 10 is a table showing an example of a data string in which antenna-setting pairs are arranged according to the communication quality, to be obtained in the process of the control procedure according to the present invention;

FIG. 11 is a table showing an example of antenna-setting pairs, to be obtained in the process of the control procedure according to the present invention;

FIG. 12 is a conceptual diagram for explaining the main beam and side-lobes in a phased-array antenna or the like;

FIG. 13A is a schematic diagram showing a case where a signal emitted from the main beam of an antenna of one of the communication devices is received by the main beam of an antenna of the other communication device;

FIG. 13B is a schematic diagram showing a case where a signal emitted from the main beam of an antenna of one of the communication devices is received by a side-lobe of an antenna of the other communication device;

FIG. 14 is a table showing an example of a data string in which antenna-setting pairs are arranged according to the communication quality, to be obtained in the process of the control procedure according to the present invention;

FIG. 15 is a table showing an example of antenna-setting pairs, to be obtained in the process of the control procedure according to the present invention;

FIG. 16 is a table showing an example of antenna-setting pairs, to be obtained in the process of the control procedure according to the present invention;

FIG. 17 is a table showing an example of antenna-setting pairs, to be obtained in the process of the control procedure according to the present invention;

FIG. 18 is a table showing an example of antenna-setting pairs, to be obtained in the process of the control procedure according to the present invention;

FIG. 19A is a sequence diagram showing an operation of a communication device before radio communication is performed in a radio control procedure according to a first exemplary embodiment of the present invention;

FIG. 19B is a sequence diagram showing an operation of a communication device before radio communication is performed in a radio control procedure according to a first exemplary embodiment of the present invention;

FIG. 20 is a sequence diagram showing an operation of a communication device in the case of shielding of radio communication being occurred in a radio control procedure according to a first exemplary embodiment of the present invention;

FIG. 21A is a sequence diagram showing a part of an operation of a communication device in a radio control procedure according to a fourth exemplary embodiment of the present invention;

FIG. 21B is a sequence diagram showing a part of an operation of a communication device in a radio control procedure according to a fourth exemplary embodiment of the present invention;

FIG. 22 is a plane view showing an example of a propagation environment to which the present invention is applied;

FIG. 23 is a plane view showing an example of a propagation environment to which the present invention is applied;

FIG. 24 is a table showing an example of a data string describing a relation between antenna settings and received powers, to be obtained in the process of the control procedure according to the present invention;

FIG. 25 is a table showing an example of a data string describing a relation among antenna settings, beam directions, and communication qualities, to be obtained in the process of the control procedure according to the present invention;

FIG. 26 is a table showing an example of a graph showing a relation between beam directions and communication qualities, to be obtained in the process of the control procedure according to the present invention;

FIG. 27 is a table showing an example of antenna setting candidates, to be obtained in the process of the control procedure according to the present invention;

FIG. 28 is a table showing an example of a graph showing a relation between beam directions and communication qualities, to be obtained in the process of the control procedure according to the present invention;

FIG. 29 is a table showing an example of antenna setting candidates, to be obtained in the process of the control procedure according to the present invention;

FIG. 30A is a figure for illustrating a radio wave propagation state where propagation paths are created as a result of local reflections of radio signals (when radio waves are not blocked) in radio control procedure according to a first exemplary embodiment of the present invention and;

FIG. 30B is a figure for illustrating a radio wave propagation state where propagation paths are created as a result of local reflections of radio signals (when radio waves are blocked by a human body) in radio control procedure according to a first exemplary embodiment of the present invention;

FIG. 31 shows a configuration of a system using wide-angle antennas; and

FIG. 32 shows an example of a delay profile of a system using wide-angle antennas when the system is used indoors.

### DESCRIPTION OF EMBODIMENTS

Specific exemplary embodiments to which the present invention is applied are explained hereinafter in detail with reference to the drawings. The same signs are assigned to the same components throughout the drawings, and duplicate explanation is omitted as appropriate for clarifying the explanation.

### First Exemplary Embodiment

A radio communication system according to this exemplary embodiment includes transceivers 400 and 500 having a directivity-controllable antenna for beam forming. There is no particular restriction on the directivity control mechanism of the directivity-controllable antenna of the transceivers 400 and 500. For example, the directivity-controllable antenna of the transceivers 400 and 500 may be a phased array antenna, a sector-selectable antenna, or a mechanically-movable antenna.

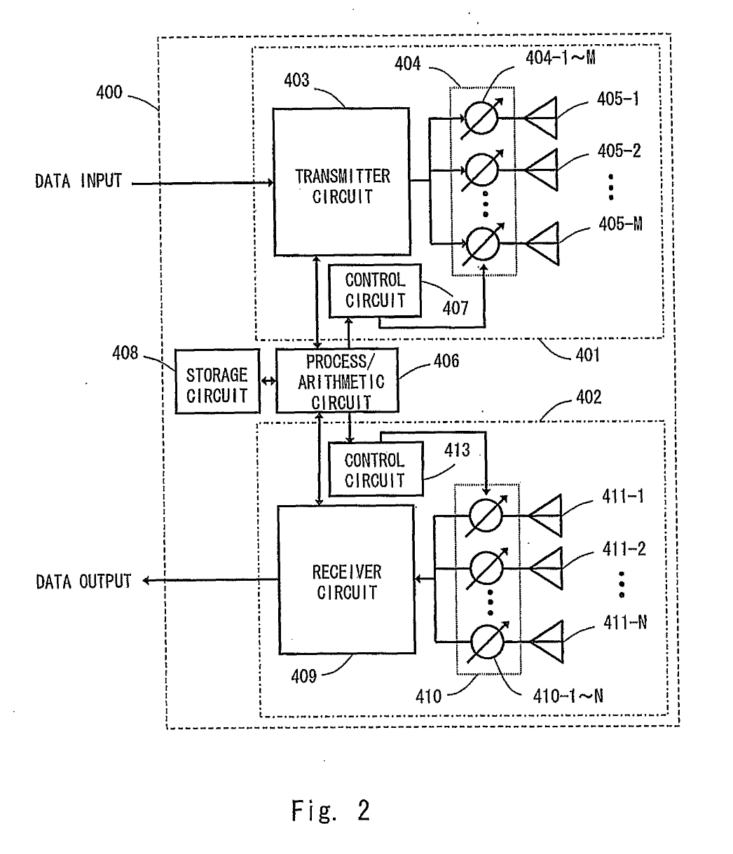

FIG. 2 shows an example of a configuration of the transceiver 400 having a phased array antenna as the directivity-controllable antenna (circuits inessential to the explanation of the operation are omitted). One antenna array includes M transmission radiating elements, and another antenna array includes N reception radiating elements. A transmitter 401 includes a transmitter circuit 403 receiving external data. The output of the transmitter circuit 403 is branched into M outputs and they are input to an antenna setting circuit 404. In the case of a phased array antenna, the antenna setting circuit 404 includes AWV (Array Weight Vector) control circuits 404-1 to 404-M. Each signal is changed in its amplitude or in its phase, or in both, and eventually output through the transmitting antenna array composed of the radiating elements 405-1 to 405-M. Each of the AWV control circuits 404-1 to 404-M can be implemented by, for example, series connection of an analog phase shifter and a variable-gain amplifier. In such a configuration, both the amplitude and phase of the signal are controlled in a continuous manner. If the AWV control circuits 404-1 to 404-M are implemented by digital phase shifters, only the phases of the signals are controlled in a discrete manner.

A process/arithmetic circuit 406 provides instructions about the setting of the antenna setting circuit 404 through a control circuit 407. By changing both or either of the amplitude and the phase of each signal, it is possible to control the direction, the width, or the like of the beam emitted from the transmitter.

Meanwhile, a receiver 402 has a reversed configuration to the transmitter 401. Signals received by a receiving antenna array composed of radiating elements 411-1 to 411-N are adjusted in both or either of the amplitude and the phase in AWV control circuits 410-1 to 419-N and combined. Then, a receiver circuit 409 receives the combined signal, and outputs data externally. As in the case of the transmitter 401, a process/arithmetic circuit 406 controls both or either of the amplitude and phase of each of the AWV control circuits 410-1 to 419-N.

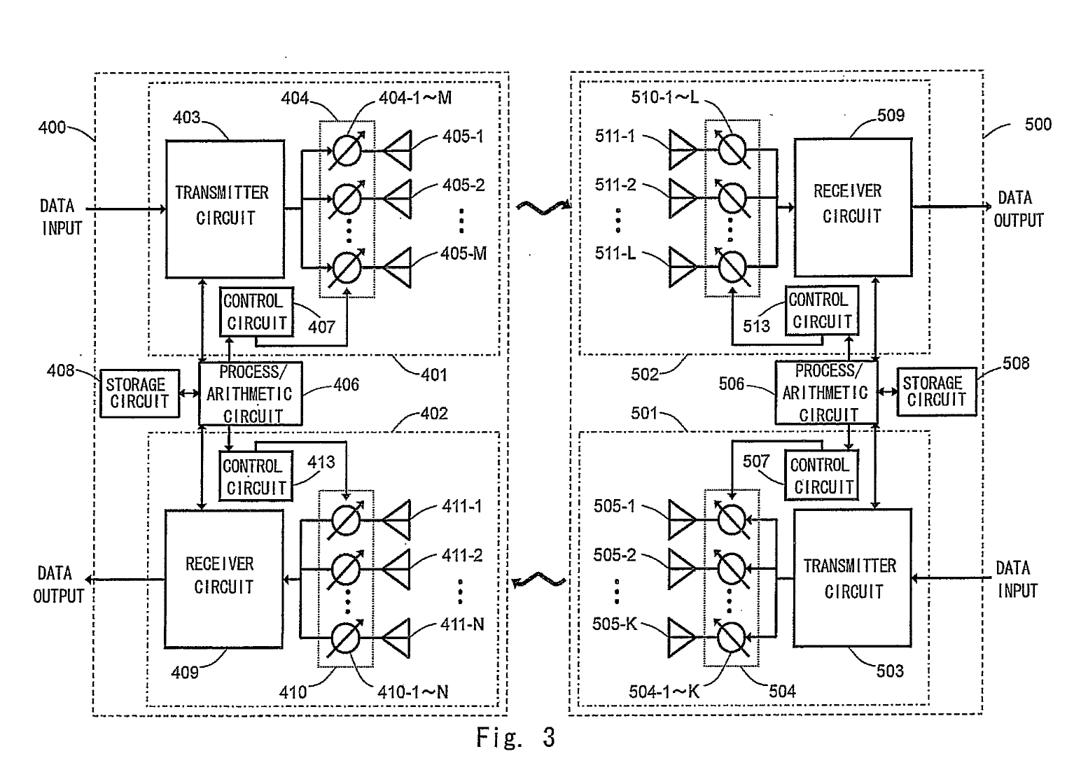

FIG. 3 is a conceptual diagram of a radio communication system including two transceivers (400 and 500) each having the configuration shown in FIG. 2. As an example, the transceiver 500 has K transmission radiating elements and L reception radiating elements.

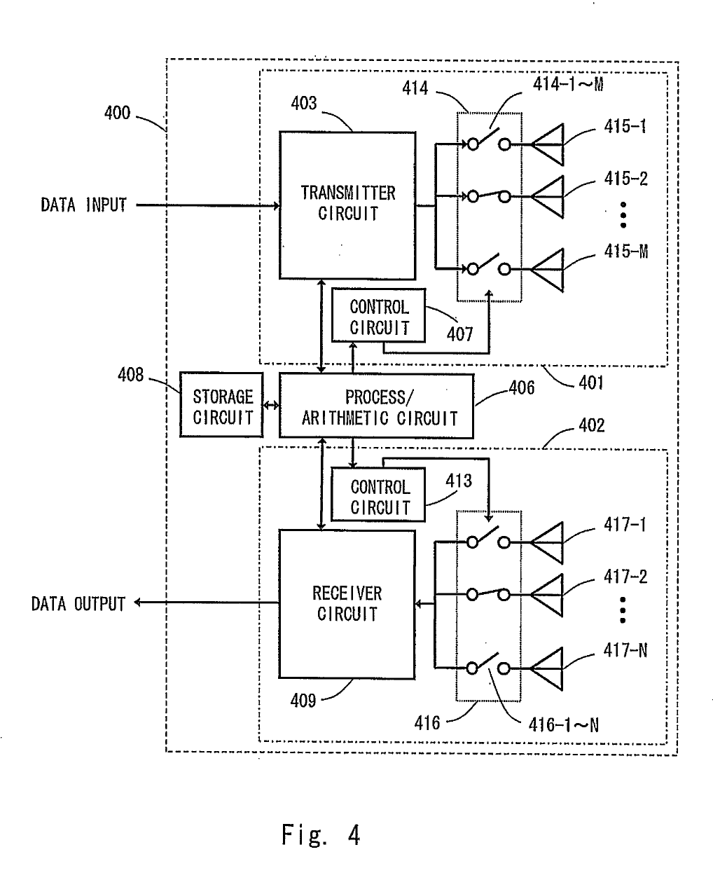

In FIGS. 2 and 3, a configuration example of a communication device including a phased array antenna as the directivity-controllable antenna is shown. However, communication devices including other types of antennas as the directivity-controllable antenna have been also known. FIG. 4 is a configuration example of a transceiver 400 including a sector-selectable antenna as the directivity-controllable antenna. In this case, radiating elements having strong directivity are used as the transmission radiating elements 415-1 to 415-M and the reception radiating elements 417-1 to 417-N, and these radiating elements are arranged to point different directions from one another. The antenna setting circuits 414 and 416 usually include switch elements 414-1 to 414-M and 416-1 to 416-N respectively. A beam is formed in the emitting direction of a radiating element whose switch is turned on. Therefore, it is possible to control the beam direction by changing the antenna setting by using the antenna setting circuits 414 and 416. The operations of the other circuits are similar to those of the circuits shown in FIG. 2.

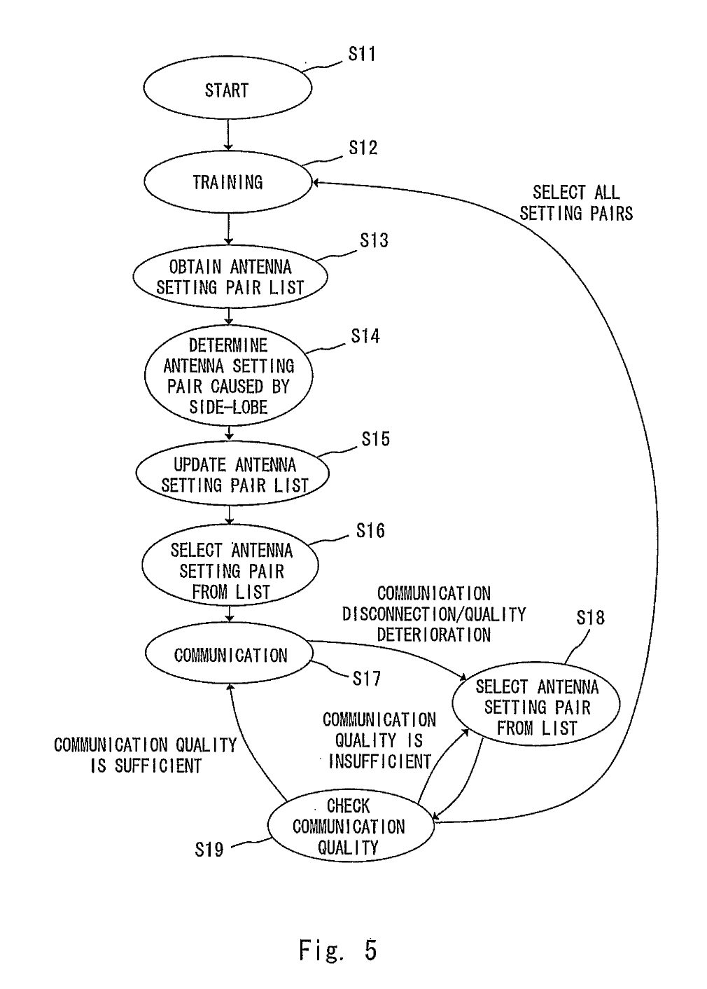

An overall radio control procedure in a radio communication system according to this exemplary embodiment is explained with reference to a transition diagram shown in FIG. 5. In states S12 in FIG. 5, the transceiver 400 and 500 perform a training to optimize their antenna setting circuits 404, 410, 504 and 510. In a state S13, either the process/arithmetic circuit 406 or the process/arithmetic circuit 506, or both of the process/arithmetic circuits 406 and 506 in cooperation determine and obtain antenna-setting pair candidates (i.e., antenna-setting pair list) based on the training result obtained in the state S12. The method of determining antenna-setting pair candidates performed in the states S12 and S13 is explained later. The obtained antenna-setting pair candidates are stored in storage circuits 408 and 508, or in one of them, in the form of a data string.

Note that as described above, the antenna-setting pair means a combination of an antenna setting for a transmitting antenna and an antenna setting for a receiving antenna. The antenna setting may be any setting information that defines a directivity pattern (e.g., beam direction or beam pattern) of a transmitting antenna or a receiving antenna. For example, when a phased array antenna is used as the directivity-controllable antenna as shown in FIG. 2, an AWV may be used as the antenna setting. Alternatively, when the directivity-controllable antenna is a sector-selectable antenna as shown in FIG. 4, the antenna setting may be On/Off setting of the switch elements 414-1 to 414-M. Further, for example, the antenna setting may be an identification number that is associated in advance with certain directivity, or may be an antenna setting value itself that determines the directivity such as an AWV.

In a state S14, among antenna-setting pair candidates obtained in the state S13, an antenna-setting pair(s) that is caused by a side-lobe is determined. Details of the determination method of an antenna-setting pair(s) caused by a side-lobe performed in the state S14 are explained later. Next, in a state S15, the antenna-setting pair list is updated by using the determination result obtained in the state S14. The update means deleting an antenna-setting pair(s) caused by a side-lobe from the antenna-setting pair list, lowering the priority rank of that antenna-setting pair(s) in the antenna-setting pair list, or carrying out a similar operation.

In a state S16, one of the antenna-setting pair candidates updated in the state S15 is selected and communication is started in a state S17. The method of selecting an antenna-setting pair performed in the state S16 is also explained later. During the communication, the transceivers 400 and 500 monitor the communication state. For example, when the transceiver 500 is operated for reception, the communication quality may be measured in the receiver circuit 509 or the process/arithmetic circuit 506. For example, communication quality such as a received-signal level, a signal to noise ratio (SNR), a bit error rate (BER), a packet error rate (PER), and a frame error rate (FER) may be measured. Meanwhile, the monitoring of the communication state in the transceiver 400, which is operated as a transmitter at this time, may be implemented by measuring a reception status of a communication quality deterioration alert from the transceiver 500 or a reception status of a reception confirmation response (ACK). It should be noted that since publicly-known common techniques may be used as the communication state monitoring technique, detailed explanation of the monitoring technique in this exemplary embodiment is omitted.

When deterioration in communication quality such as disconnected communication is detected during the communication, the transceivers 400 and 500 select another antenna-setting pair from the data string (antenna-setting pair list) stored in both or either of the storage circuits 408 and 508 (S18).

In a state S19, it is determined whether the quality of the communication using the newly-selected antenna-setting pair is satisfactory or not. When the transceiver 500 is operated for reception, for example, the receiver circuit 509 or the process/arithmetic circuit 506 determines whether the communication quality is satisfactory or not by measuring a received-signal level, an SNR, or the like. When the communication quality is determined to be satisfactory in the state S19, the transceivers 400 and 500 return to the communication state (S17). On the other hand, when the communication quality is determined to be unsatisfactory in the state S19, the transceivers 400 and 500 change to the state S18 and select an antenna-setting pair again.

As an alternative form of operation, when the transceivers 400 and 500 change from the state S17 to the state 18, the transceivers 400 and 500 may check the communication quality of all or some of the antenna-setting pairs included in the antenna-setting pair list updated in the state S15 and resume the communication by using an antenna-setting pair having good communication quality based on the check result.

When any antenna-setting pair having a satisfactory communication state is not found from the antenna-setting pairs stored in the storage circuits 408 and 508, the procedure retunes to the training (S12) and repeats the operations from there.

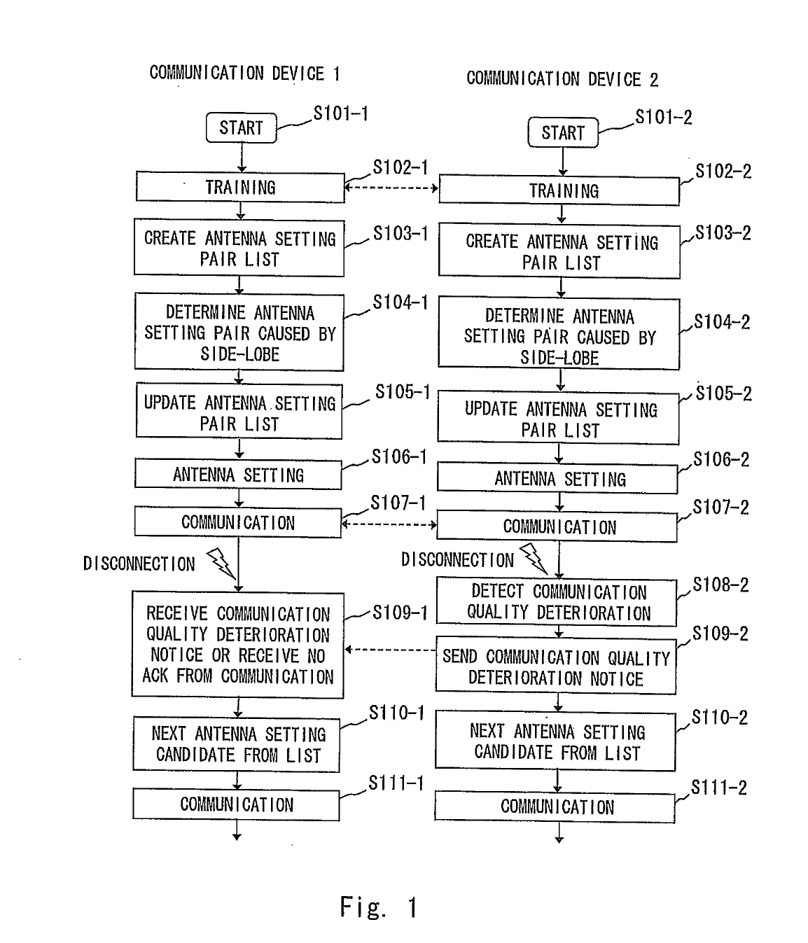

FIG. 1 is a simplified sequence diagram showing the operation of each communication device in each procedure explained above with reference to the transition diagram shown in FIG. 5. For the sake of simplicity, the step corresponding to the communication quality check (S19) shown in FIG. 5 is omitted in FIG. 1. An operation including the communication quality check (S19) that is performed when the communication quality deteriorates is explained later in detail. In the following explanation, a procedure and an operation are explained while simultaneously referring to the simplified sequence diagram shown in FIG. 1 and the configuration diagram of the radio communication system shown in FIG. 3, Note that the transceiver 400 and the transceiver 500 are shown as “communication device 1” and “communication device 2” respectively in FIG. 1 for the sake of simplicity.

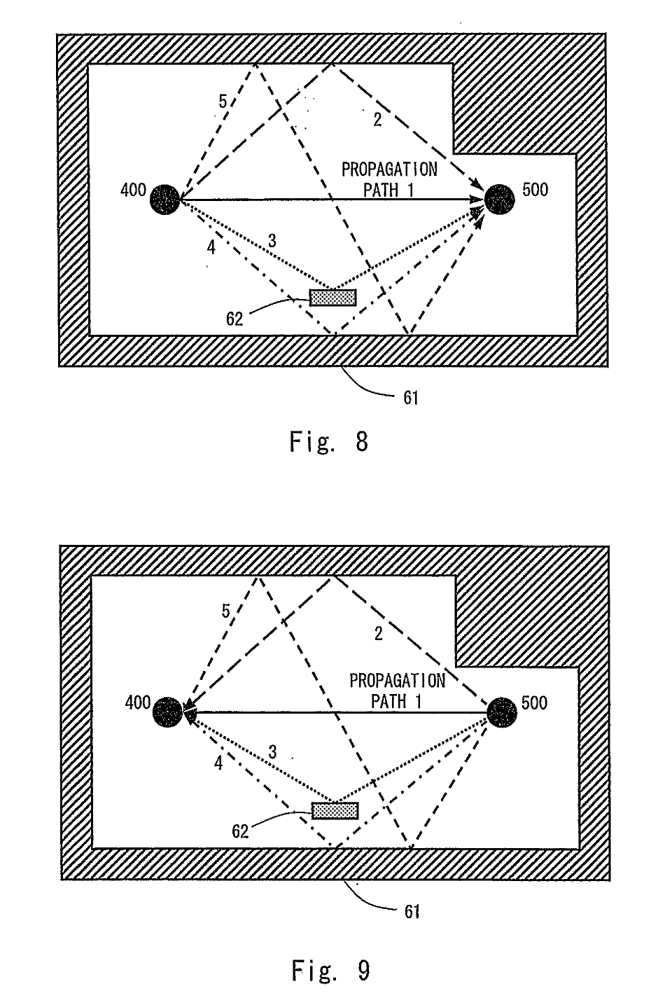

As an example, assume a propagation environment shown in FIGS. 8 and 9. FIG. 8 shows a case where a training signal propagates from the communication device 1 to the communication device 2 and FIG. 9 shows an opposite case. In this example, the communication device 1, the communication device 2, and a reflective body 62 are disposed inside a room (two dimensions) enclosed with a wall 61. Assume that there are five propagation paths available for communication, which are indicated as symbols 1 to 5, between the communication devices 1 and 2.

Steps S102-1 and S102-2 shown in FIG. 1 are a training for determining a plurality of antenna-setting pairs of the transmitting antenna of the communication device 1 (transceivers 400) and the receiving antenna of the communication device 2 (transceivers 500) and a plurality of antenna-setting pairs of the receiving antenna of the communication device 1 and the transmitting antenna of the communication device 2.

In this operation, firstly, a communication quality test is carried out for a plurality of combinations between transmitting antenna setting candidates of the communication device 1 and receiving antenna setting candidates of the communication device 2. In this operation, the storage circuit 408, the process/arithmetic circuit 406, the control circuit 407, and the antenna setting circuit 404 of the communication device 1 work together and thereby change the antenna setting of the transmitting antenna (e.g., antenna array 405-1 to 405-M). In this way, the communication device 1 successively changes the main beam direction of the transmitting antenna array 405-1 to 405-M. Further, the transmitter circuit 403 also works together in that state. In this way, the communication device 1 transmits a training signal while successively changing the transmission main beam direction.

Similarly, the storage circuit 508, the process/arithmetic circuit 506, the control circuit 507, and the antenna setting circuit 510 of the communication device 2 work together and thereby change the antenna setting of the receiving antenna (e.g., antenna array 511-1 to 511-L). In this way, the communication device 2 successively changes the main beam direction of the receiving antenna array 511-1 to 511-L. Further, the receiver circuit 509 also works together in that state. In this way, the communication device 2 receives a training signal while successively changing the reception main beam direction.

In general, when the main beam direction of the transmitting antenna of the communication device 1 and the main beam direction of the receiving antenna of the communication device 2 match well with one of a plurality of propagation paths existing between the communication devices, the training signal emitted from the transceivers 400 arrives at the transceivers 500 through the propagation path and thus good communication quality is obtained. Further, it is expected that when an antenna-setting pair corresponding to a propagation path having a smaller path-loss is selected, better communication quality is obtained.

Next, the communication devices 1 and 2 interchange their roles, and perform similar operations. That is, a communication quality test is carried out for a plurality of combinations between receiving antenna setting candidates of the communication device 1 and transmitting antenna setting candidates of the communication device 2. This procedure is similar to the above-described procedure, and therefore its explanation is omitted. With these operations, the training step in the step S102 is finished. A step (S103) of creating an antenna-setting pair list by using the training result obtained in the step S102 is explained hereinafter.

In the above explanation, there is no particular restriction on the selection method of a plurality of antenna setting candidates for each of the four antennas (i.e., transmitting antenna and receiving antenna of each of communication devices 1 and 2). As an example, a method of selecting 32 antenna setting candidates for each of the transmitting antenna of the communication device 1 and the receiving antenna of the communication device 2 in advance is explained hereinafter. Assume that these antenna setting candidates are identified from one another by assigning antenna setting identification numbers (IDs) 0 to 31. The 32 antenna setting candidates may be selected so that, for example, their main beam directions are distributed at regular angular intervals over the angle range that should be covered by the communication device. Note that the term “in advance” means that the selection is made before the beam forming training is started, i.e., the selection is made without depending on the propagation environment. Another example in which antenna setting candidates are selected according to the propagation environment during the beam forming training will be also explained later with another exemplary embodiment. Further, only the training between the transmitting antenna of the communication device 1 and the receiving antenna of the communication device 2 is explained in the following explanation. That is, since the training between the receiving antenna of the communication device 1 and the transmitting antenna of the communication device 2 is similar to the above-mentioned training, its explanation is omitted.

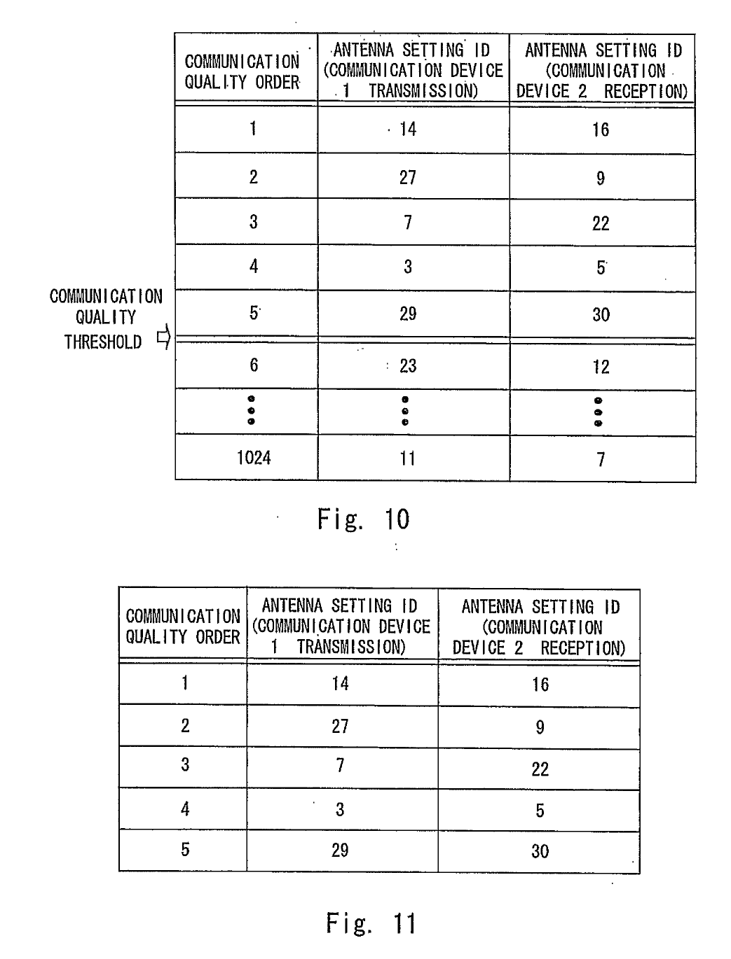

By using reception signal characteristics obtained in the training in the step S102, it is possible to obtain all the combinations between 32 antenna setting candidates for the transmitting antenna of the communication device 1 and 32 antenna setting candidates for the receiving antenna of the communication device 2 (i.e., 1024 combinations in this example). By arranging the combinations of the antenna setting candidates (i.e., antenna-setting pairs) in descending order of communication quality, a table shown in FIG. 10, for example, is obtained. As for the communication quality, an index such as a received-signal level, a signal to noise ratio (SNR), and a bit error rate (BER), for example, may be used.

Note that it is desirable to define an appropriate threshold for the communication quality and delete antenna-setting pairs whose communication quality is below the threshold from the list. Assuming that the communication qualities of the antenna-setting pairs ranked in the sixth and lower places are lower than the threshold in the example shown in FIG. 10, the antenna-setting pair list becomes one shown in FIG. 11. Alternatively, the number of setting pairs to be stored in the antenna-setting pair list may be determined in advance. Then, setting pairs whose ranks determined according to the communication quality are not within the upper limit number for the storage may be deleted. Alternatively, the communication quality threshold and the upper limit number for the storage may be both determined in advance. Then, only when the number of antenna-setting pairs whose communication quality is higher than the communication quality threshold exceeds the upper limit number for the storage, setting pairs that are not within the upper limit number for the storage may be deleted. Needless to say, depending on circumstances, the table shown in FIG. 10 may be used as it is as the antenna-setting pair list without deleting any antenna-setting pair. These operations may be performed by the process/arithmetic circuit 406 and/or 506. The created antenna-setting pair list may be stored in the storage circuit 408 and/or 508.

The above explanation is made on the assumption that antenna-setting pairs are stored in the antenna-setting pair list in descending order of communication quality. However, when the intervals between the main beam directions of the antenna setting candidates for which the communication quality test is carried out are small, there is a possibility that a plurality of antenna-setting pairs on and around one propagation path are ranked in high places according to their communication quality and thereby incorporated into the list. When this one propagation path is blocked by a shielding obstacle or the like, those antenna-setting pairs become unavailable simultaneously. Therefore, it is undesirable to store those antenna-setting pairs in the antenna-setting pair list. In such cases, it is desirable to determine antenna-setting pairs to be stored in the antenna-setting pair list by performing peak detection or the like by using information on the main beam directions of antenna setting candidates. These operations may be also performed by the process/arithmetic circuit 406 and/or 506.

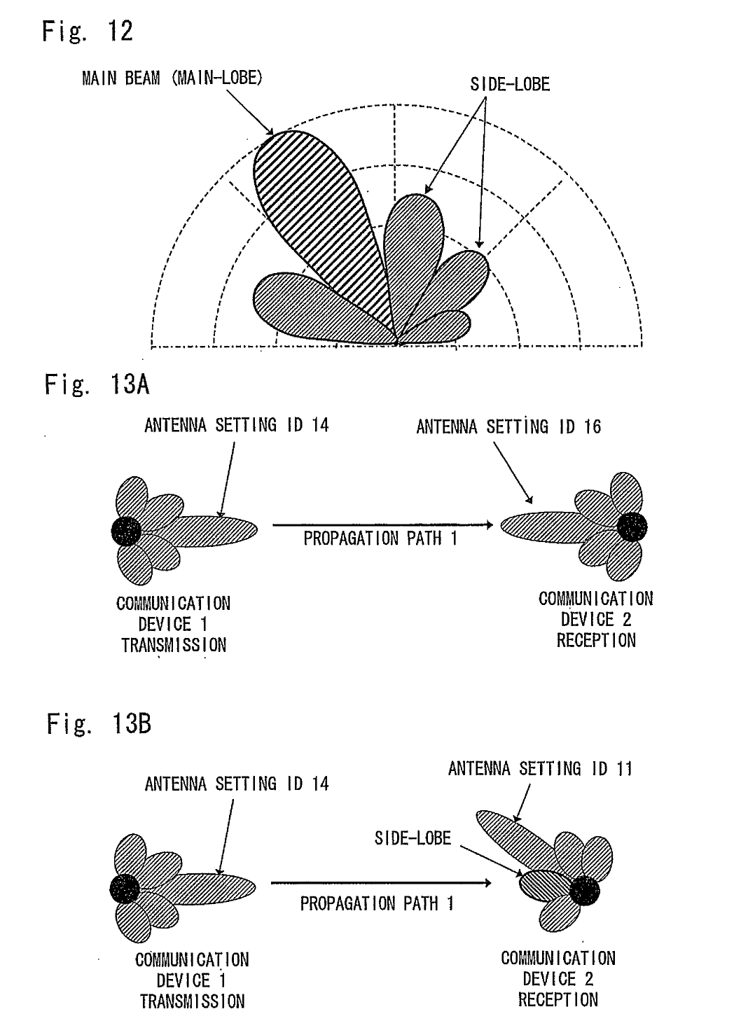

In the above explanation, it is stated that the main beam direction of each antenna is changed. However, in real antennas, in particular, phased array antennas, there is an electric field emission component(s) called side-lobe(s) in addition to the main beam (main-lobe). FIG. 12 shows an aspect of such a situation.

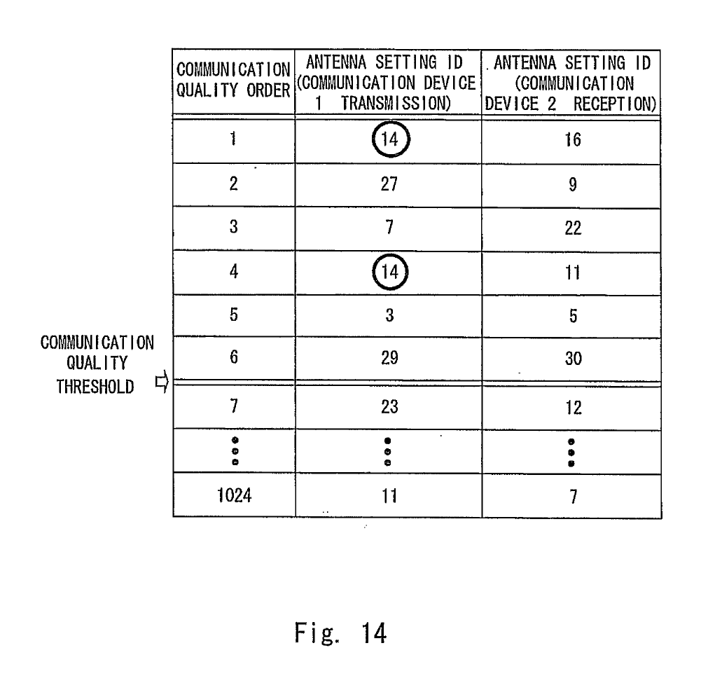

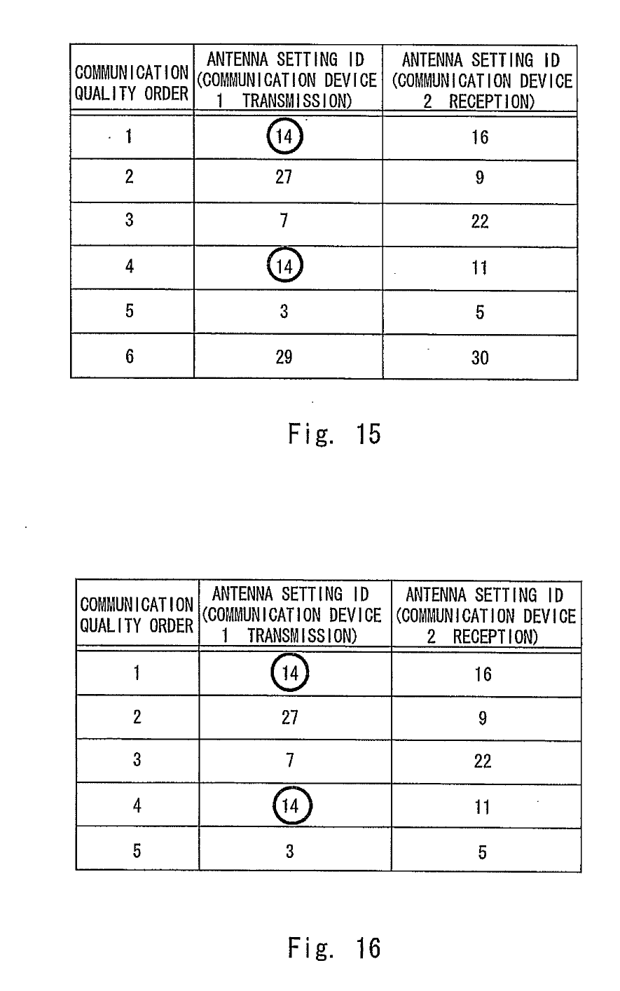

The explanation made above with reference to FIGS. 10 and 11 is made for cases where the effect of side-lobes is negligible because, for example, the levels of the side-lobes are sufficiently small in comparison to the main-lobe. However, when an antenna having a relatively large side-lobe level is used, a situation like one shown in FIGS. 13A and 13B occurs. That is, the receiving antenna of the communication device 2, having a relatively large side-lobe level, receives a signal emitted from the transmitting antenna of the communication device 1 by both of the main-lobe in one antenna setting (FIG. 13A) and the side-lobe in another antenna setting (FIG. 13B). In such situations, there are cases where the communication quality obtained when the signal is received by the side-lobe is larger than the communication quality of an antenna-setting pair(s) in which the main-lobe directions of both antennas are pointed in a propagation path having a larger path-loss. In particular, when the propagation path shown in FIGS. 13A and 13B is an LOS (Line of Sight) propagation path and the difference between its path-loss and the path-loss of other NLOS (Non-Line of Sight) propagation paths is large or when the side-lobe level of the antenna is not sufficiently small in comparison to the main-lobe level, for example, the phenomenon like this tends to occur. FIG. 14 shows an example of a table that is obtained by arranging antenna-setting pairs according to the communication quality in such cases. The antenna-setting pair that is ranked in the fourth place according to the communication quality is a setting pair that is caused by a side-lobe. FIG. 15 shows an antenna-setting pair list that is created based on a communication quality threshold. FIG. 16 shows an alternative antenna-setting pair list that is created based on an upper limit number for the storage.

In both case of FIGS. 15 and 16, antenna-setting pairs corresponding to the same propagation path are stored in the list. However, the propagation path itself is the same. Therefore, when one of the setting pair becomes unavailable because of the blockage of the propagation path or the like, the other setting pair also becomes unavailable simultaneously. This is to waste one transition from the state S18 to the state S19 in the transition diagram shown in FIG. 5, and thereby causing an increase in the processing time. Therefore, the value of an antenna-setting pair(s) caused by a side-lobe is low as an antenna-setting pair to be stored in the list. Therefore, it is desirable to delete such setting pair(s) from the list in terms of the beam forming processing time. Further, when the list is created based on the upper limit number for the storage as shown in FIG. 16, there is another possible harmful effect that a setting pair(s) that should be stored could be eliminated from the list.

In a step S104, an antenna-setting pair(s) caused by a side-lobe is identified through a procedure explained below. When attention is focused on the antenna setting identification numbers in the antenna-setting pair list (FIG. 11) obtained in the case where no side-lobe effect occurs, there is no identification number that appears twice or more for each antenna. In contrast to this, in the antenna-setting pair list (FIG. 15 or 16) obtained in the case where a side-lobe effect occurs, there is an identification number that appears twice for the antenna of the communication device (transmitting antenna of the communication device 1 in this example) located on the opposite side of the antenna (receiving antenna of the communication device 2) in which transmission or reception is performed by the side-lobe. It is possible to determine that an antenna-setting pair(s) not ranked in the highest place according to the communication quality among a plurality of antenna-setting pairs that include the same identification number is an antenna-setting pair caused by the side-lobe. These operations may be performed by the process/arithmetic circuit 406 and/or 506.

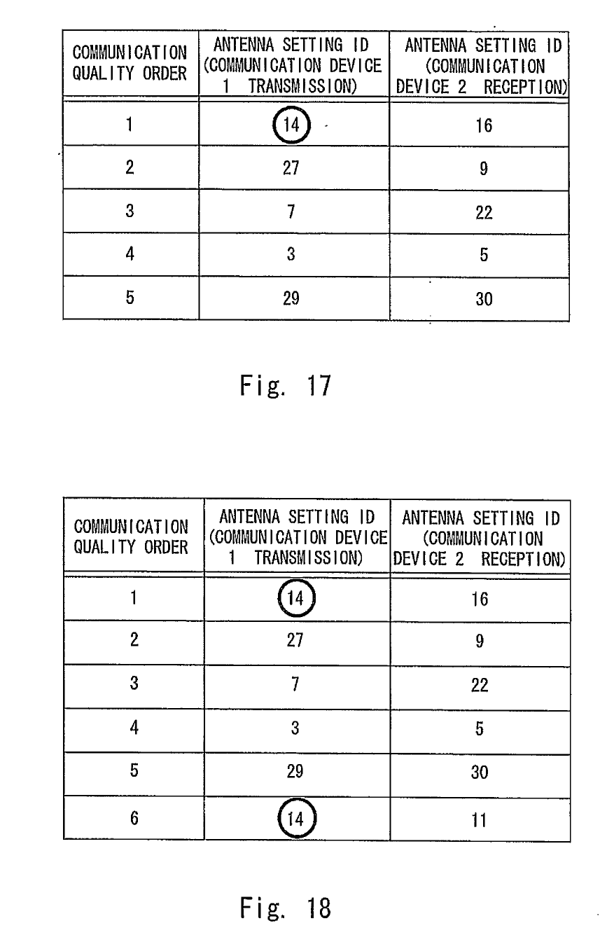

In the subsequent step S105, the antenna-setting pair list is updated based on the identification result obtained in the step S104. In the case of the antenna-setting pair list shown in FIG. 15, which is creased based on the communication quality threshold, a setting pair that is determined to be caused by a side-lobe, for example, may be deleted from the list and the list may be updated as shown in FIG. 17. Alternatively, the priority rank of a setting pair that is determined to be caused by a side-lobe may be lowered and the list may be updated as shown in FIG. 18. In the case of the antenna-setting pair list shown in FIG. 16, which is creased based on the upper limit number for the storage, there is a possibility that a setting pair(s) that should be stored is deleted from the list as described above. Therefore, the table shown in FIG. 14, which is obtained by arranging antenna-setting pairs according to the communication quality, is read out again. Then, after the setting pair(s) caused by the side-lobe is deleted or its priority rank is lowered in the table, a list including as much setting pairs as the upper limit number for the storage is created again. These operations may be performed by the process/arithmetic circuit 406 and/or 506. The updated antenna-setting pair list may be stored in the storage circuit 408 and/or 508.

Next, the communication devices 1 and 2 select one antenna-setting pair from the antenna-setting pair list updated in the step S105, set the selected antenna-setting pair in the antenna setting circuits 404, 410, 510 and 504 (S106), and start the communication (S107). Typically, the selection of an antenna-setting pair may be performed so that an antenna-setting pair having the highest communication quality is selected.

When the communication using the selected antenna-setting pair deteriorates and the deterioration is detected in the steps S108 and S109, the communication devices 1 and 2 select another antenna-setting pair from the antenna-setting pairs stored in the storage devices 408 and 508 and resume the communication (S111). In the operations described above, it is desirable to select an antenna-setting pair, for example, in the order of the storage of the antenna-setting pairs, i.e., in the order of the communication quality. Note that the steps S108 and 109 shown in FIG. 1 show a case where the communication quality is deteriorated in a state where the communication device 1 is performing transmission and the communication device 2 is performing reception. On the other hand, if the communication quality is deteriorated in a state where the communication device 2 is performing transmission and the communication device 1 is performing reception, a similar operation may be performed in a state where the roles of the communication devices 1 and 2 are interchanged.

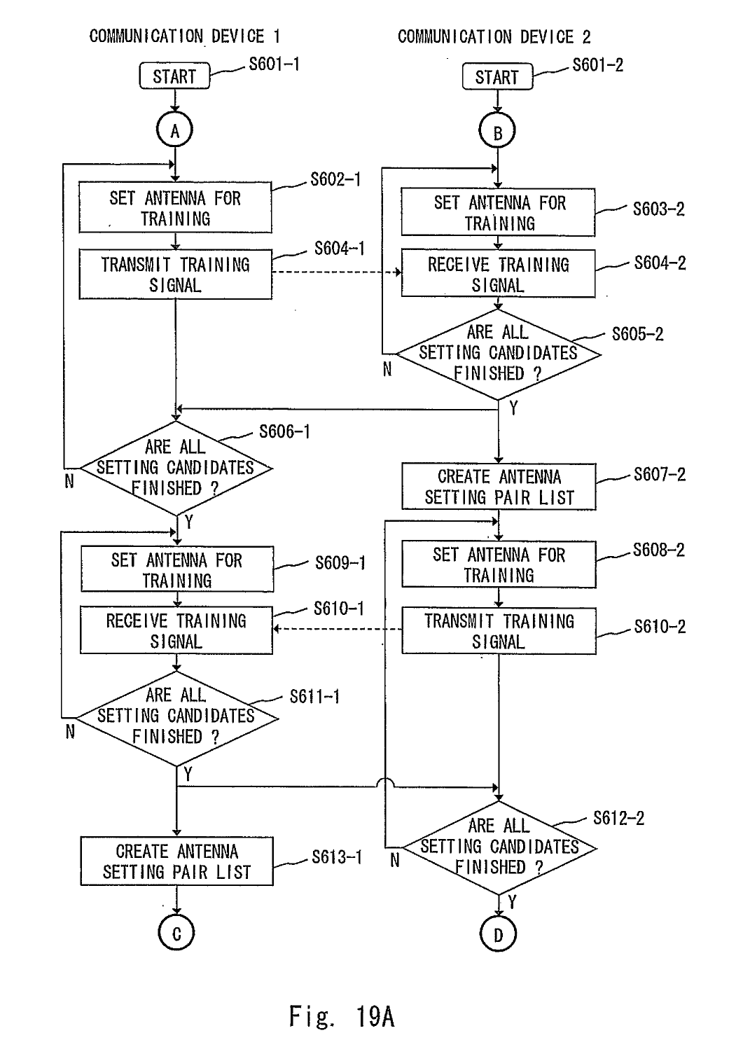

Next, the operation that is explained above with reference to the simplified sequence diagram shown in FIG. 1 is explained in a more detailed manner. FIGS. 19A and 19B are a sequence diagram showing the procedure from the start of a training (S101) to the start of communication (S107) shown in the simplified sequence diagram of FIG. 1 in a more detailed manner. The operation of the part that is simplified in FIG. 1 is explained hereinafter.

Steps S602 to S613 show an example of the procedure performed in the steps S102 and S103 shown in FIG. 1 in a more detailed manner.

Firstly, in steps S602 to S606, trainings (communication quality tests) are performed in a round-robin basis for a plurality of combinations between transmitting antenna setting candidates of the communication device 1 and receiving antenna setting candidates of the communication device 2. The communication device 1 sets a first antenna setting among the transmitting-antenna setting candidates (S602-1) and transmits a training signal (S604-1). The communication device 2 repeatedly receives a training signal (S604-2) while successively setting the receiving-antenna setting to each one of the antenna setting candidates (S603-2) until signal receptions in all the antenna setting candidates have been completed (S605-2). The above-described procedure is repeated until the procedure has been completed for all the transmitting-antenna setting candidates of the communication device 1 (S606-1). The communication device 2 creates an antenna-setting pair list for the transmitting antenna of the communication device 1 and the receiving antenna of the communication device 2 based on the reception result obtained in the step S604-2 (S607-2).

Next, in steps S608 to S612, trainings (communication quality tests) are performed in a round-robin basis for a plurality of combinations between transmitting antenna setting candidates of the communication device 2 and receiving antenna setting candidates of the communication device 1. These operations are similar to those in the above-described steps S602 to S606 except that the roles of the communication devices 1 and 2 are interchanged, and therefore their explanation is omitted. The communication device 1 creates an antenna-setting pair list for the transmitting antenna of the communication device 2 and the receiving antenna of the communication device 1 based on the reception result obtained in the step S610-1 (S613-1).

Note that when peak detection or a similar operation is carried out in the creation process of an antenna-setting pair list performed in the steps S607-2 and S613-1, it is desirable to add information of the transmission beam direction to the training signal in the training signal transmission operation performed in the steps s604-1 and S610-2. Alternatively, a frame that is used to separately send information of the transmission beam direction may be prepared and sent.

Further, when round-robin trainings among antenna setting candidates between the communication devices, it is desirable to acquire, for example, information about the number of antenna setting candidates of the communication device on the other side. For example, it is desirable to exchange such information in an interval between the steps S601 and S602, though it is not illustrated in FIGS. 19A and 19B.

Next, in a step S614, an antenna-setting pair(s) caused by a side-lobe is determined by using the above-described method. In this example, the communication device 2 determines the antenna-setting pair caused by a side-lobe for the transmitting antenna of the communication device 1 and the receiving antenna of the communication device 2 (S614-2), and the communication device 1 determines the antenna-setting pair caused by a side-lobe for the transmitting antenna of the communication device 2 and the receiving antenna of the communication device 1 (S614-1).

In the subsequent step S615, the antenna-setting pair list is updated so that the determination result of the antenna-setting pair caused by a side-lobe obtained in the step S614 is reflected in the updated antenna-setting pair list. The update of the antenna-setting pair list means deleting an antenna-setting pair(s) caused by a side-lobe from the antenna-setting pair list, lowering the priority rank of an antenna-setting pair(s) caused by a side-lobe in the antenna-setting pair list, or carrying out a similar operation. Similarly to the step S614, in this example, the communication device 2 updates the antenna-setting pair list for the transmitting antenna of the communication device 1 and the receiving antenna of the communication device 2 (S615-2), and the communication device 1 updates the antenna-setting pair list for the transmitting antenna of the communication device 2 and the receiving antenna of the communication device 1 (S615-1).

In the subsequent steps S616 and S617, the antenna-setting pair list updated in the step S615 is transmitted and received. In the step S616, the antenna-setting pair list for the transmitting antenna of the communication device 2 and the receiving antenna of the communication device 1 is sent from the communication device 1 to the communication device 2. On the other hand, in the step S617, the antenna-setting pair list for the transmitting antenna of the communication device 1 and the receiving antenna of the communication device 2 is sent from the communication device 2 to the communication device 1.

In a step S618, both communication devices have a common antenna-setting pair number that is used for the communication to be performed in a subsequent step. In this example, an antenna-setting pair number is sent from the communication device 1 to the communication device 2. Note that the antenna-setting pair number is any kind of number that can be used to identify each antenna-setting pair included in the antenna-setting pair list. For example, communication quality rank numbers in FIG. 17 or 18 may be used as the antenna-setting pair number. Alternatively, instead of sending the antenna-setting pair number, the antenna setting identification number itself may be sent. In a step S619, antenna setting is carried out according to the common antenna-setting pair number obtained in the step S618, and the communication is started in a step S620.

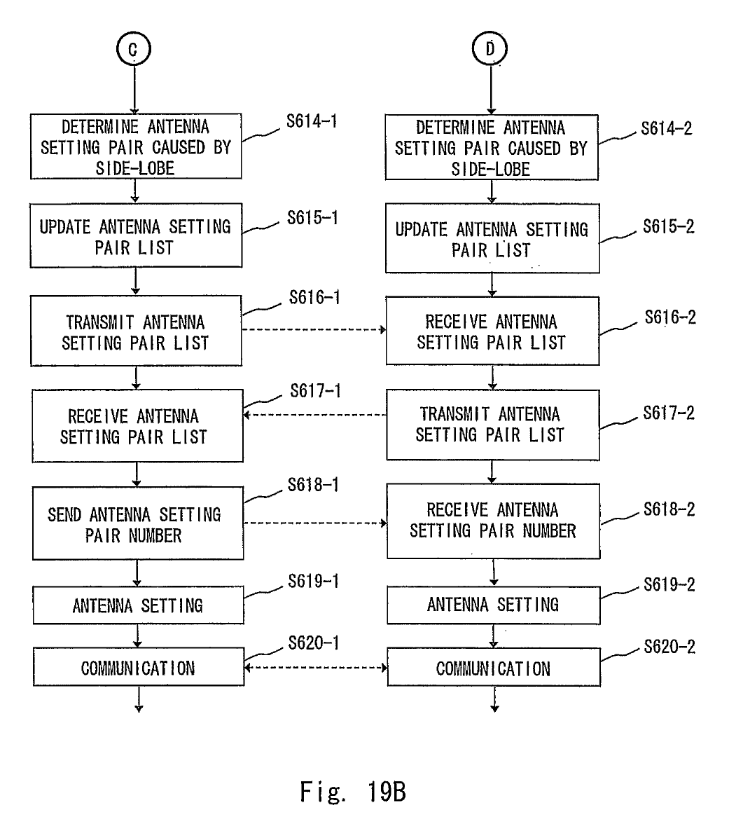

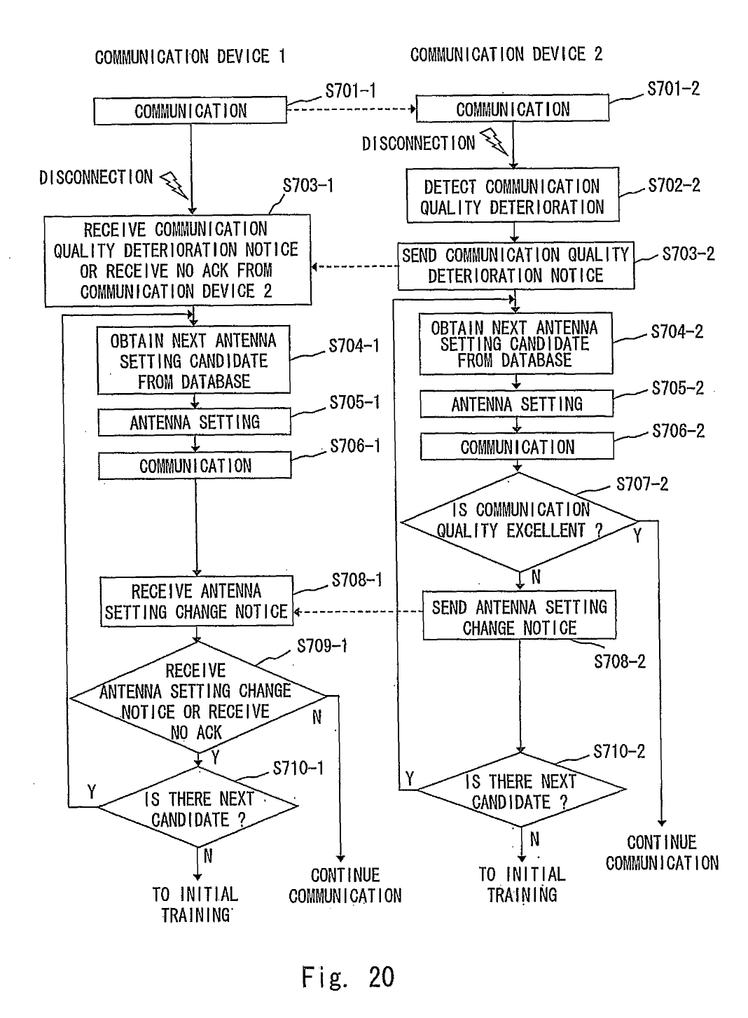

Next, an operation performed when deterioration in communication quality such as the disconnected communication shown in the steps S107 to S111 in FIG. 1 occurs is explained with reference to FIG. 20. FIG. 20 is a sequence diagram showing operations of the transceivers 400 and 500 in the transition operations from the state S17 to S19 in FIG. 5. Note that in the following explanation, a case where the transceiver 400 (communication device 1 in FIG. 20) is operated for transmission and the transceiver 500 (communication device 2 in FIG. 20) is operated for reception is explained.

When a problem such as disconnected communication occurs, the transceiver 500, which is performing the receiving operation, detects the deterioration in communication quality (S702-2), and notifies the transceiver 400 of the deterioration (S703-2). The transceiver 400 receives the notification of the communication quality deterioration from the transceiver 500. Alternatively, the transceiver 400 recognizes the disconnected communication (or deteriorated communication state) based on the fact that the ACK signal, which would be transmitted from the transceiver 500 upon the successful data reception under normal communication circumstances, has not been received. At this point, the transceivers 400 and 500 obtain their respective next antenna setting candidates from their own databases (i.e., antenna-setting pair list) (S704-1 and S704-2).

In a step S705-1, the transceiver 400 sets the antenna setting circuit 404 with the next antenna setting candidate. Similarly, in a step S705-2, the transceiver 500 sets antenna setting circuit 510 with the next antenna setting candidate. After that, the transceivers 400 and 500 resume the communication (S706-1 and S706-2). After the communication is resumed, the transceiver 500 checks the communication quality (S707-2). When the communication quality is satisfactory, the communication is continued, whereas when it is unsatisfactory, the transceiver 500 transmits a notice of antenna setting change (S708-2). The transceiver 400 continues the communication without making any change unless it receives the notice of antenna setting change or cannot receive an ACK signal from the transceiver 500 (S709-1). If not so, the transceivers 400 and 500 attempt the communication using the next antenna-setting pair candidate as long as there is another antenna setting candidate (S710-1 and S710-2). If the communication quality cannot be improved with any of the antenna-setting pair candidates stored in the storage devices 408 and 508 and there is no remaining candidate, the transceivers 400 and 500 returns to the training.

The procedure described above in this exemplary embodiment is merely an example. For example, there is flexibility in the order of those steps, the communication devices that perform various processing/calculation, the content of transmitted/received information, and so on. Therefore, various cases where any of these matters is different from those shown in the above exemplary embodiment are also included the scope of the present invention.

According to this exemplary embodiment, it is possible to avoid, when antenna-setting pairs corresponding to a plurality of propagation paths available for communication are obtained and stored in advance by carrying out trainings in order to perform radio communication with beam-forming, one of the adverse effects caused by a side-lobe of the antenna (emergence of an antenna-setting pair(s) caused by a side-lobe) by using a simple method. Since the identification of an antenna-setting pair(s) caused by a side-lobe can be performed without sending a training signal in this exemplary embodiment, it is possible to improve the antenna-setting pair list without causing a significant increase in the training time.

The following is supplementary explanation for the reason why this method is effective for millimeter waves or microwaves that are higher than or equal to around 10 GHz and have a high rectilinear propagation property when the method is used indoors. The propagation paths that can be used for radio communication are limited. That is, only the direct wave and reflected waves from certain objects such as walls, windows, and furniture can be used. Therefore, angles at which waves (signals) should be emitted for respective propagation paths or angles at which waves (signals) should be received are widely different from one wave (signal) to another. Meanwhile, when propagation paths having a low rectilinear propagation property such as a 2.4 GHz micro waveband are used, it is necessary to give consideration to effects caused by multiple scattering and diffraction. Therefore, in general, directional antennas are not used. Therefore, situations are different between communication using microwaves and millimeter waves that have higher than or equal to around 10 GHz and communication using microwaves in the order of 2.4 GHz. It should be noted that there are some examples of development of adaptive antennas having directivity for the purpose of eliminating interferences even in the field of communication using 2.4 GHz microwaves. However, even when an adaptive-type directional antenna is used, it is relatively easy to ensure satisfactory communication quality at the angle of the direct wave or angles close to the direct wave in the 2.4 GHz band because diffraction effects can be expected in the 2.4 GHz band.

In indoor communication using beam forming in millimeter wavebands, it is necessary to take the following properties into consideration. As described above, the number of reflected waves other than the direct wave is limited. Further, even if a certain direct wave or a reflected wave is blocked by an obstacle (e.g., human body), there is no correlation between the blocked certain wave and other waves. Therefore, as described with this exemplary embodiment, in millimeter wave communication systems, it is possible to secure reserve beam directions while performing communication in a beam direction having the best communication condition. Meanwhile, when the frequency is lower than around 10 GHz, contribution of multiple reflections and diffractions on the communication quality is large. Therefore, even if a directional antenna is used, the propagation state of the reserve beam directions varies depending on the presence/absence of an obstacle. That is, there is a high possibility that a received signal state of a reserve beam direction, which has satisfactory quality when no obstacle exists, is changed due to the presence of an obstacle. Therefore, it is difficult to obtain an advantageous effect of the present invention in 2.4 GHz microwave communication and the like.

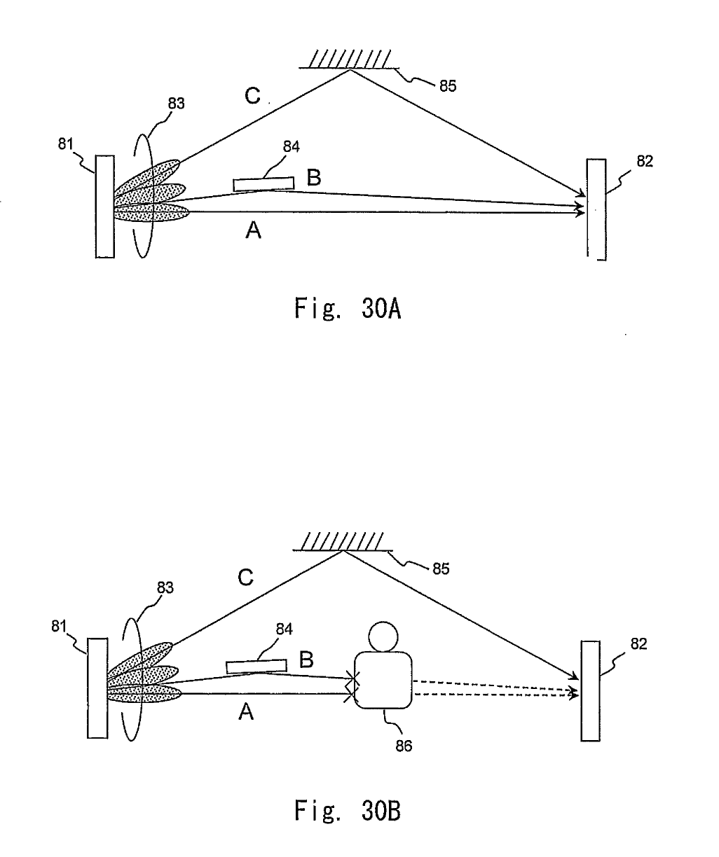

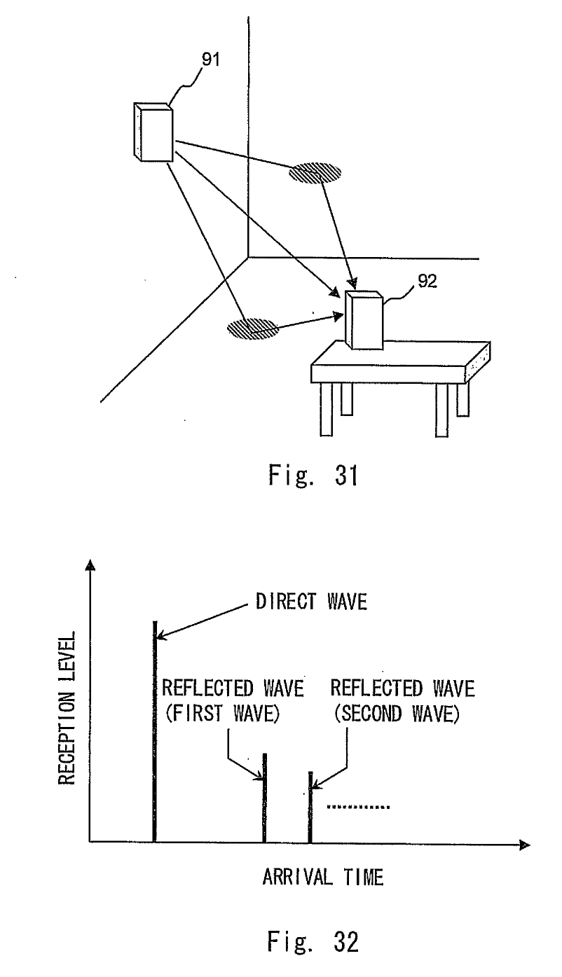

Further, in millimeter wave communication, a local reflection may sometimes create a propagation path. FIGS. 30A and 30B show an aspect of such a situation. In FIG. 30A, there are a transceiver 81 and a receiver 82, and it is assumed that there are propagation paths in the beam forming including a direct wave A, a locally reflected wave B, and a reflected wave C propagating through a long path. There is a possibility that the direct wave A and the locally reflected wave B are blocked at the same time, for example, by a human body. To cope with this problem, Patent literature 1 discloses a technique to give no or a low priority to a beam direction close to another beam direction to which a priority is already assigned has no or a low priority. Although examples in which priority order is assigned to antenna-setting pairs in the order of received power (or other communication quality) has been described so far in the above explanation, it is also possible to take angular relations between beam candidates (antenna-setting candidates) into account in addition to the criterion based on the received power in the assignment of the priority order. Since information about angular relations between beam candidates in the respective communication devices is already obtained in this exemplary embodiment, it is possible to perform the priority order assignment like this.

In the above explanation, beam forming between two communication devices is explained. Such operations are often performed between two communication devices in a system including three or more communication devices. In general, there is a communication device having special authority called “Piconet coordinator” or “access point” in the system. The decision on which two communication devices perform a beam forming operation therebetween among the three or more communication devices is typically made by instructions from this communication device called “Piconet coordinator” or “access point”. The Piconet coordinator or the access point may receive requests from other general communication devices and issue these instructions.

Further, in this exemplary embodiment, the roles of two communication devices are interchanged and then similar operations are performed therebetween. The decision on which of the two communication devices performs which of the roles before the other communication device may be also made by instructions from the communication device called “Piconet coordinator” or “access point”.

Further, although expressions such as “to operate a communication device for reception” and “to successively set the antenna setting to each one of the antenna setting candidates” are used in the above explanation, these operations may be, in general, performed in accordance with a program that are incorporated in advance into the process/arithmetic circuits 406 and 506 or the like of the transceivers 400 and 500.

### Second Exemplary Embodiment

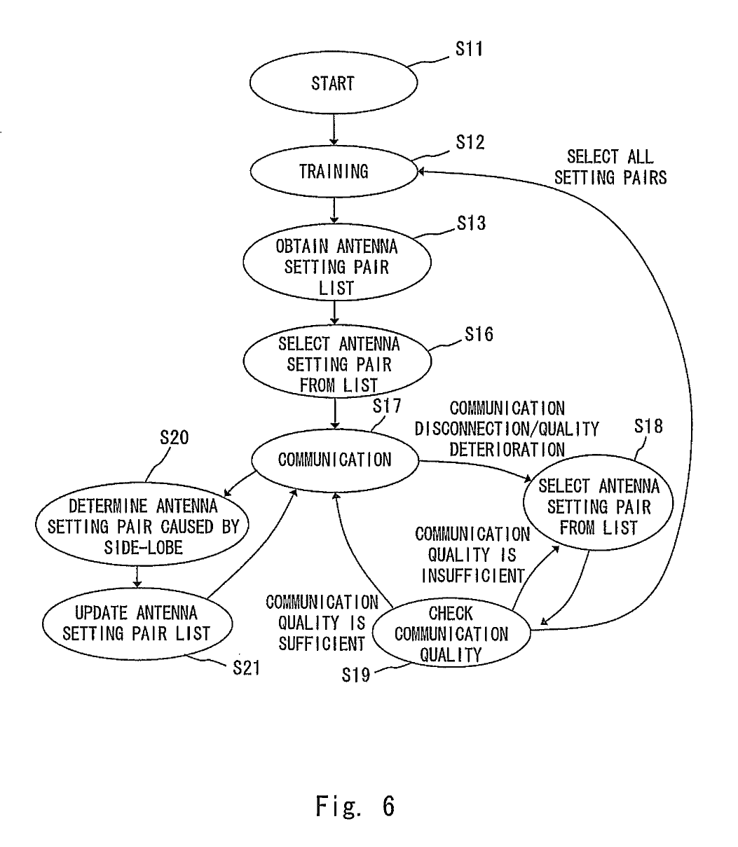

A second exemplary embodiment according to the present invention is explained with reference to a transition diagram shown in FIG. 6. Note that the configuration of a radio communication system according to this exemplary embodiment may be similar to that of the first exemplary embodiment shown in FIG. 3. Each of states S11 to S13 and S16 to S19 and transition conditions therebetween in FIG. 6 are similar to the states assigned with the same signs and their transition conditions shown in FIG. 5 described above with the first exemplary embodiment. Therefore, detailed explanation of the states S11 to S13 and S16 to S19 is omitted.

In the first exemplary embodiment shown in FIG. 5, the determination of an antenna-setting pair(s) caused by a side-lobe (S14) and the update of the antenna-setting pair list (S15) are performed before the communication start (S17). In contrast to this, the determination of an antenna-setting pair(s) caused by a side-lobe (S20) and the update of the antenna-setting pair list (S21) are performed after the state is changed from the communication state (S17) in this exemplary embodiment. The operations in the states S20 and S21 may be performed as appropriate during an idle period during which no data is transmitted/received. The operations may be divided and performed in intervals of the communication.

In this exemplary embodiment, the communication is started by using an antenna-setting pair ranked in the highest place (antenna-setting pair having the highest communication quality). Then, the determination of an antenna-setting pair(s) caused by a side-lobe and the update of the antenna-setting pair list are performed by using an idle period(s) or the like during the communication. As a result, it is possible to shorten the time required before the communication starts. The method like this can be adopted without causing any problem because the antenna-setting pair ranked in the highest place cannot be caused by a side-lobe.

### Third Exemplary Embodiment

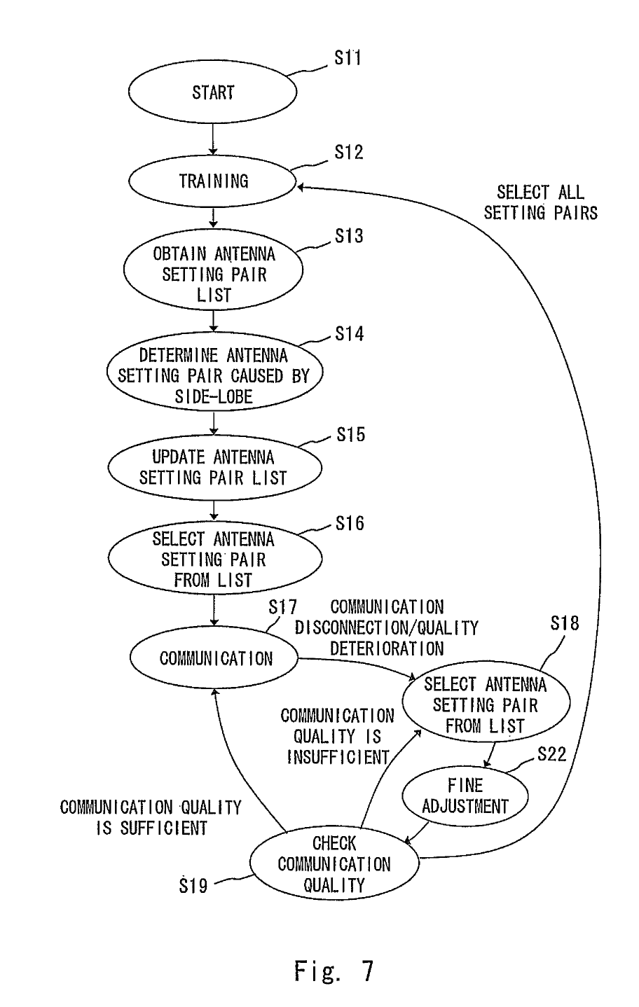

A third exemplary embodiment according to the present invention is explained with reference to a transition diagram shown in FIG. 7. Note that the configuration of a radio communication system according to this exemplary embodiment may be similar to that of the first exemplary embodiment shown in FIG. 3. Further, each of states S11 to S19 and transition conditions therebetween (except for transition between S18 and S19) in FIG. 7 are similar to the states assigned with the same signs and their transition conditions shown in FIG. 5 described above with the first exemplary embodiment. Therefore, detailed explanation of the states S11 to S19 is omitted.

In this exemplary embodiment, when deterioration in communication quality such as disconnected communication occurs, the next antenna-setting pair candidate listed on the antenna-setting pair list is selected (S18) and a fine adjustment is made in that state (S22). The fine adjustment means a method for searching for an optimal beam (antenna setting) without spending too much time. Specifically, the fine adjustment may be performed by slightly changing the antenna setting and thereby changing the beam direction so that better communication quality is obtained. Further, simplified beam searching procedure such as “Beam Tracking” disclosed in Patent literature 4 may be applied. Furthermore, operations similar to those of the initial training may be performed with an angular resolution higher than that in the initial training in and around the beam direction corresponding to the newly-selected antenna-setting pair.

For example, in a case where the antenna-setting pair is shifted from one antenna-setting pair to another in descending order of their corresponding received power as described in detail with the first exemplary embodiment, there is a possibility the received power becomes gradually smaller and the accuracy deteriorates gradually. Accordingly, this exemplary embodiment provides an advantageous effect that an antenna-setting pair with which stable transmission can be performed with high accuracy can be found, for example, by performing a gain adjustment for the receiving operation and thereby performing a fine adjustment in the optimal state in a state where shielding occurs and the received power is thereby weakened.

### Fourth Exemplary Embodiment

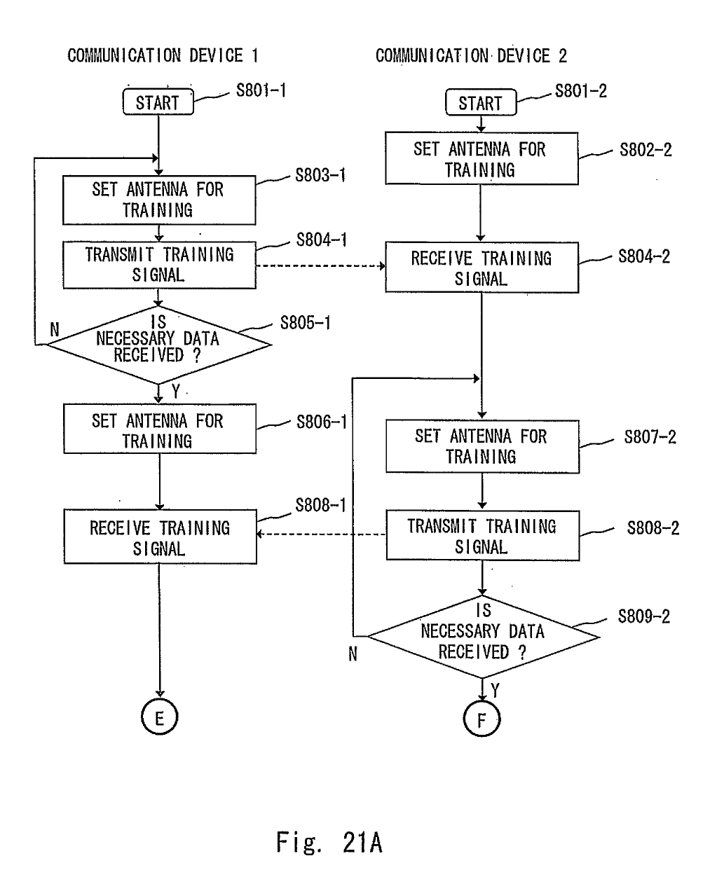

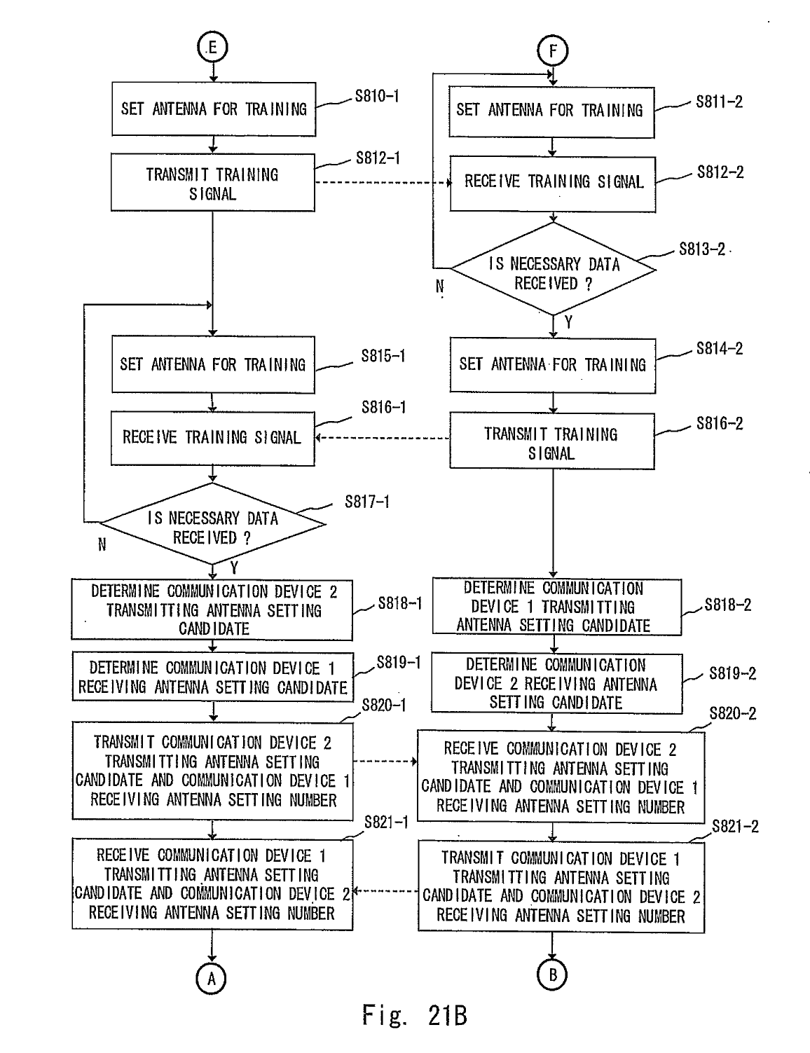

A fourth exemplary embodiment according to the present invention is explained with reference to a sequence diagram shown in FIGS. 21A and 21B. This sequence diagram should be inserted between the start (S601) and A and B in FIG. 19A. Further, after the steps in FIG. 21B are finished, the steps at and after A and B in FIG. 19A may be performed.

In the first exemplary embodiment, the method in which a plurality of antenna setting candidates for each of the four antennas (transmitting antenna and receiving antenna of each of communication devices 1 and 2) are selected in advance is described. In such cases, antenna setting candidates may be selected so that, for example, their main beam directions are distributed at regular angular intervals over the angle range that should be covered by the communication device. Note that the term “in advance” means that the selection is made before the beam forming training is started, i.e., the selection is made without depending on the propagation environment. However, in general, when the angle range used for communication is to be covered with sufficient angular resolution, it is necessary to prepare a large number of antenna setting candidates for each antenna. In such cases, it is necessary to carry out communication quality tests for all the combinations of a number of transmitting and receiving-antenna setting candidates. Therefore, there are cases where the training time becomes enormously longer. To cope with this problem, in this exemplary embodiment, an example of a method in which antenna setting candidates are selected according to the propagation environment during the beam forming training is explained.

In steps S802 to S805, training signal that is used to select antenna setting candidates for the transmitting antenna of the communication device 1 according to the propagation environment is transmitted and received. Firstly, the communication device 2 sets the receiving-antenna setting with values for a fixed pattern, i.e., values for generating an omni or quasi-omni pattern in this example (S802-2). The communication device 1 repeatedly transmits training signal (S804-1) while changing the transmitting-antenna setting (S803-1) until signal transmissions in all of the predetermined antenna settings have been completed (S805-1). In this operation, identification numbers corresponding to respective antenna settings or equivalent information are transmitted. The communication device 2 receives the training signals and the antenna setting identification numbers (S804-2). Note that when the transmitting-antenna setting is successively changed, it may be set with such antenna settings that their main beam directions are distributed at regular angular intervals over the angle range that should be covered by the communication device.

Similarly, in steps S806 to S809, training signal that is used to select antenna setting candidates for the transmitting antenna of the communication device 2 is transmitted and received. These operations are similar to those in the above-described steps S802 to S805 except that the roles of the communication devices 1 and 2 are interchanged, and therefore their explanation is omitted.

In steps S810 to S813, training signal that is used to select antenna setting candidates for the receiving antenna of the communication device 2 according to the propagation environment is transmitted and received. Firstly, the communication device 1 sets the transmitting-antenna setting with values for a fixed pattern, i.e., values for generating an omni or quasi-omni pattern in this example (S810-1) and sends out a training signal (S812-1). The communication device 2 repeatedly receives the training signal (S812-2) while changing the receiving-antenna setting (S811-2) until signal receptions in all of the predetermined antenna settings have been completed (S813-2).

Similarly, in steps S814 to S817, training signal that is used to select antenna setting candidates for the receiving antenna of the communication device 1 is transmitted and received. These operations are similar to those in the above-described steps S810 to S813 except that the roles of the communication devices 1 and 2 are interchanged, and therefore their explanation is omitted.

Through the above-described steps S802 to S817, reception results of four training signals are obtained. In the subsequent steps S818 and S819, antenna setting candidates of four antennas (transmitting antenna and receiving antenna of each of communication devices 1 and 2) are determined based on these reception results. Its specific procedure is explained hereinafter.

Firstly, it is explained hereinafter that a procedure for determining transmitting antenna setting candidates of the communication device 1 in a step S818-2 by using the training signal reception result obtained in the step S804-2 is explained.

A data string describing a relation between antenna settings of the transmitting antenna (i.e., transmission beam directions) of the communication device 1 and received-signal powers in the receiving antenna of the communication device 2 is obtained from the training signal reception result in the step S804-2. The antenna setting of the transmitting antenna of the communication device 1 is sent from the transmission device 1 to the transmission device 2 in advance by, for example, adding the antenna settings to the information element of the training signal when the training signal is transmitted in the step S804-1. Note that although a data string describing a relation between antenna settings and received-signal powers is obtained in this example, received signal characteristics indicating communication quality other than the received power may be also used. Examples of the received signal characteristics other than the received power include a signal to noise ratio (SNR).

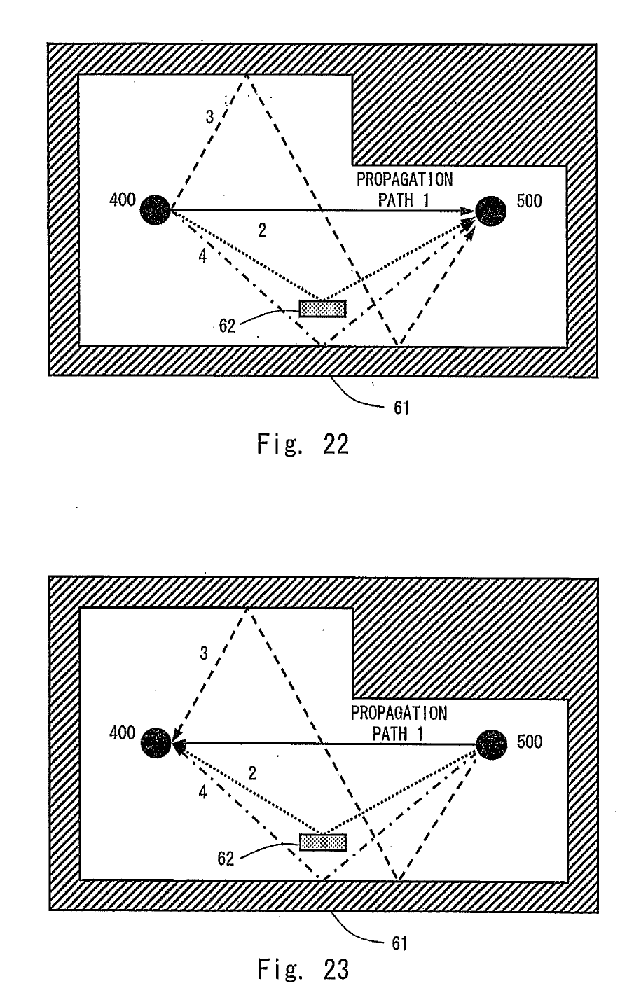

The following explanation is made by using an example of two-dimensional propagation environment in which there are four propagation paths as shown in FIGS. 22 and 23. Assume an example in which the main beam direction is scanned in increments of 4° over an angle range of 120° when a training signal is transmitted and received while changing the antenna setting in the training. Assume that the antenna setting candidates are identified from one another by assigning antenna setting identification numbers (IDs) 0 to 30.

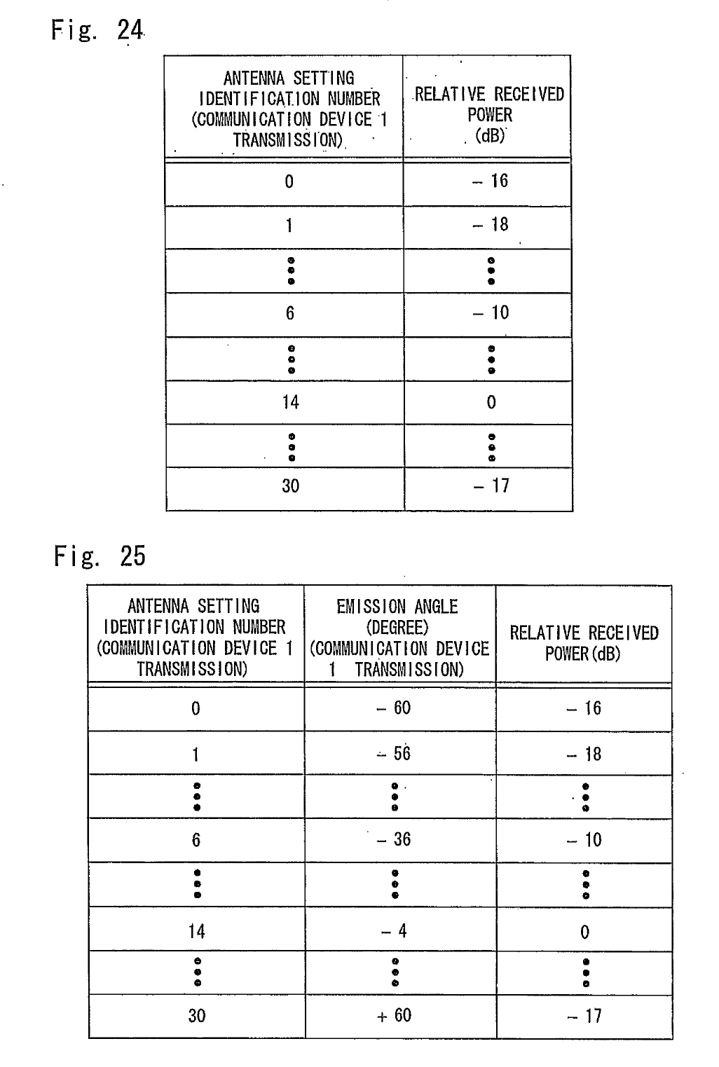

FIG. 24 shows an example of a data string. In this example, a relation between identification numbers of antenna settings of the communication device 1 (transceivers 400) and relative received powers in the communication device 2 (transceivers 500) is described. Note that the relative received powers are expressed in such a manner that the maximum received power among the received powers corresponding to all the antenna settings for which the training was carried out is defined as 0 dB and the other received powers are expressed by their ratios to the maximum received power. When the angular resolution of the beam scanning performed in the step S803-1 is low, a plurality of (or one) antenna settings for which the relative received power is greater than a predetermined threshold may be selected and defined as transmitting-antenna-setting candidates of the communication device 1. Alternatively, the number of antenna settings to be detected may be determined in advance. Then, antenna settings may be selected one by one in descending order of their relative received power until the number of detected antenna settings reaches the predetermined number.

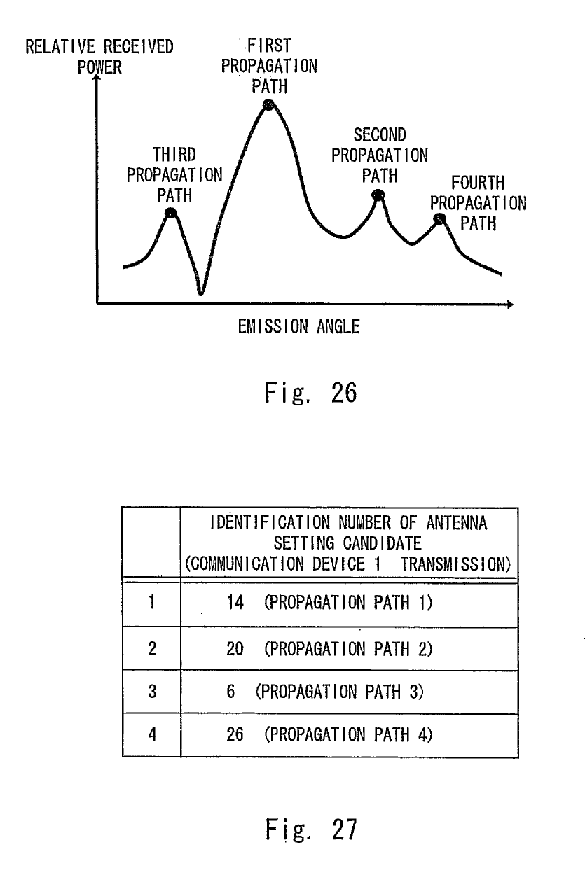

However, when the angular resolution of the beam scanning performed in the step S803-1 is high, there is a possibility that antenna settings that properly correspond to the signal paths cannot be detect by the above-described method. That is, there is a possibility that antenna settings in and around a beam direction corresponding to a relatively high received power occupy higher ranks of the relative received powers and are detected as antenna settings corresponding to the signal paths. In such cases, it is desirable to perform peak detection by using information about the scanned beam direction (emission angle) of the transmitting antenna of the transmission device 1. To that end, it is necessary to send the information about the beam direction of the transmitting antenna of the transmission device 1 in advance from the transmission device 1 to the transmission device 2. This information may be sent by adding it to the information element of the training signal transmitted in the step S804-1, or may be sent by transmitting separate data dedicated for the delivery of angle information. In such cases, the data string may be, for example, one shown in FIG. 25. By using the data string like this, it is possible to create a profile shown in FIG. 26. By performing peak detection using this profile, it is possible to detect antenna settings that properly correspond to the signal paths. Even in such cases, all the peaks may be detected. Alternatively, the number of antenna settings to be detected may be determined in advance. Then, peaks are detected one by one in descending order of their relative received power until the number of detected peaks reaches the predetermined number. The profile in FIG. 26 is shown just for illustrating a general idea, and in practice, only a data string like the one shown in FIG. 25 may be required. Further, when the identification numbers of the antenna settings are associated with beam directions, the peak detection may be performed without using the angle information.

Note that in this specification, a planar (two-dimensional) propagation environment as shown in FIGS. 22 and 23 is assumed for simplifying the explanation. Therefore, the horizontal axis in FIG. 26 indicates emission directions as one-dimensional values. It is also assumed that the antenna array has one dimension. However, the present invention can be also applied to other cases where a two-dimensional antenna array is used in a three-dimensional propagation environment. In such cases, the column of the emission angle in FIG. 25 and the horizontal axis in FIG. 26 represents two-dimensional arrays each composed of two angles.

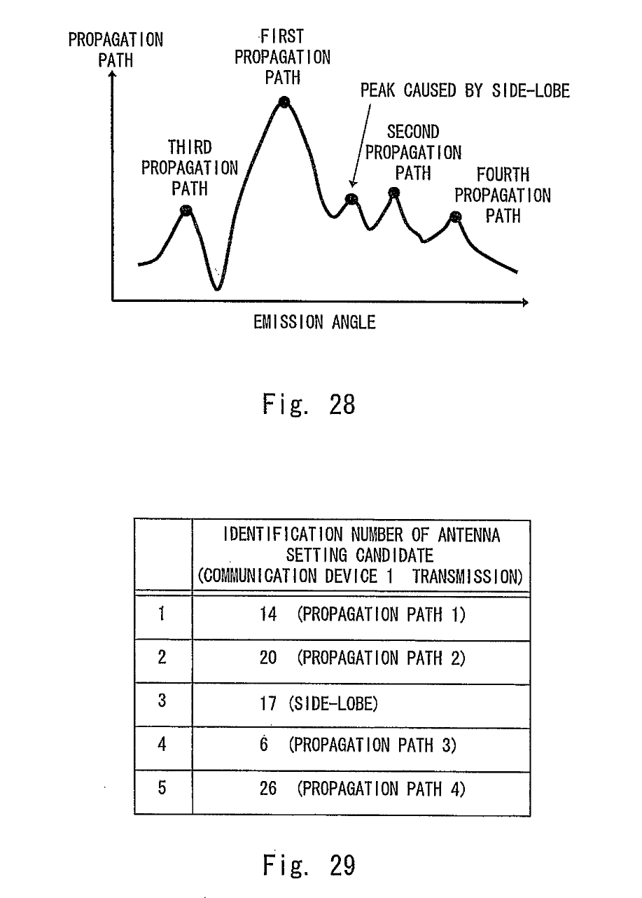

When the side-lobe effect does not occur, antenna setting candidates are detected, for example, as shown in FIG. 27. That is, the same number of antenna settings as the number of the propagation paths, each corresponding to one of the propagation paths available for communication, are detected. (i.e., four antenna settings are detected in this example.) However, when a high-level side-lobe exists in the transmitting antenna of the communication device 1, there is a possibility that high-level power is received in the communication device 2 when that side-lobe is directed to the first propagation path. In this case, the profile shown in FIG. 26 becomes one shown in FIG. 28. That is, a peak caused by the side-lobe appears in an emission direction in which no propagation path exists. The emission direction in which the peak appears is a direction of the main-lobe as the side-lobe is directed to the first propagation path. Typically, there is no propagation path in that direction. The antenna setting candidates obtained in this case are, for example, those shown in FIG. 29. That is, antenna setting caused by the side-lobe (identification number 17) is undesirably included.

A procedure for determining transmitting antenna setting candidates of the communication device 2 in a step S818-1 by using the training signal reception result obtained in the step S808-1 is similar to that performed in the above-described step S818-2, and therefore its explanation is omitted. That is, the procedure in the step S818-1 may be performed by performing the above-described procedure in the step S818-2 in a state where the roles of the communication devices 1 and 2 are interchanged.

Next, a procedure for determining receiving antenna setting candidates of the communication device 2 in a step S819-2 by using the training signal reception result obtained in the step S812-2 is explained hereinafter. A data string describing a relation between antenna settings of the receiving antenna (i.e., reception beam directions) and received powers of the communication device 2 is obtained from training signal reception result obtained in the step S812-2. The operation described below is similar to the above-described procedure for determining transmitting antenna setting candidates of the communication device 1 performed in the step S818-2. However, in this operation, training signal reception results that are obtained by scanning the reception beam direction of the receiving antenna (S812-2) are used. Therefore, in contrast to the case where a training signal is transmitted from an antenna performing beam scanning, there is no need to send the information about antenna settings and beam directions. Further, the information about the beam direction that is used to perform peak detection is incoming angles instead of the emission angles.

A procedure for determining receiving antenna setting candidates of the communication device 1 in a step S819-1 by using the training signal reception result obtained in the step S816-1 is similar to that performed in the above-described step S819-2, and therefore its explanation is omitted. That is, the procedure in the step S819-1 may be performed by performing the above-described procedure in the step S819-2 in a state where the roles of the communication devices 1 and 2 are interchanged.

Through the above-described operations, four pluralities of antenna-setting candidates of four antennas (transmitting antenna and receiving antenna of each of communication device 1 and 2) are determined. Next, the communication devices 1 and 2 transmit and receive information necessary for performing round-robin trainings between the determined antenna setting candidates (FIG. 19A). That is, in a step S820, transmitting antenna setting candidates of the communication device 2 and the total number of receiving antenna setting candidates of the communication device 1 are sent from the communication device 1 to the communication device 2. Similarly, in a step S821, transmitting antenna setting candidates of the communication device 1 and the total number of receiving antenna setting candidates of the communication device 2 are sent from the communication device 2 to the communication device 1. However, when the total number of antenna setting candidates with which the round-robin trainings are performed is determined in advance, there is no need to transfer the total number of antenna setting candidates. Further, for example, identification numbers of antenna settings may be used as the information on transmitting antenna setting candidates as shown in FIG. 29. The antenna settings may be arranged, for example, in descending order of the received power of the training signal as shown in this table.

The steps shown in FIGS. 19A and 19B are carried out by using the antenna setting candidates obtained through the above-described operations. As described above, even if an antenna setting(s) caused by a side-lobe is included in the antenna setting candidates, any setting pair including the antenna setting caused by the side-lobe is deleted from the antenna-setting pair list by performing the steps shown in FIGS. 19A and 19B.

According to this exemplary embodiment, it is possible to narrow down the number of antenna setting candidates for each antenna to a sufficiently small number through the steps using a quasi-omni pattern shown in FIGS. 21A and 21B and thereby to reduce the processing time.

### Fifth Exemplary Embodiment

A fifth exemplary embodiment is characterized in that the training and the acquiring/setting of antenna-setting pairs are performed at a low rate (with a narrow band) and actual communication is performed at a relatively high rate (with a wide band). Alternatively, it is characterized in that parts the training and the acquiring/setting of antenna-setting pairs are performed at a low rate (with a narrow band) and the remaining part of the training and the acquirement/setting of antenna-setting pairs as well as actual communication is performed at a relatively high rate (with a wide band). The other operations may be performed by using the method according to one of the first to fourth exemplary embodiments.

In millimeter wave communication, since free space propagation losses are large, the received power is expected to be small. Therefore, if an antenna is set so as to generate an omni or quasi-omni pattern in the training, there is a possibility that a sufficient CNR (Carrier to Noise Ratio) is not achieved. Accordingly, it is expected that the use of the low rate (narrow band) having better reception sensitivity provides advantageous effects such as making the training possible and improving the accuracy. It should be noted that the “use of low rate (narrow band)” means to narrow the frequency band used to transmit a training signal in order to narrow the noise bandwidth or to adopt a modulation technique having a small necessary CNR. Note that “to adopt a modulation technique having a small necessary CNR” means, in other words, to adopt a modulation technique in which the distance between signal points on the constellation is large (typically a smaller transmission rate). It should be noted that it is assumed that a narrow beam width is used in this exemplary embodiment. Therefore, there is no significant difference in optimal beam combinations (antenna-setting pairs) regardless of whether the transmission is preformed at a low rate (narrow band) or at a high rate (wide band) because the correlative bandwidth is wide.

### Other Exemplary Embodiments

In the first to fifth exemplary embodiments, examples in which each of the transceivers 400 and 500 includes both the transmitting antenna (405-1 to 405-M, or 505-1 to 505-K) and the receiving antenna (411-1 to 411-N, or 511-1 to 511-L) are shown. Further, no particular assumption is made for the relation between the length of the propagation path and the distance between the transmitting antennas 405-1 to 405-M and the receiving antennas 411-1 to 411-N of the transceivers 400. Similarly, no particular assumption is made for the relation between the length of the propagation path and the distance between the transmitting antennas 505-1 to 505-K and the receiving antennas 511-1 to 511-L of the transceivers 500. Further, cases where configurations of the transmitting antenna and the receiving antenna of each transceiver are usually different are shown. In such cases, it is necessary to perform trainings for each of the connection between the transmitting antenna of the communication device 1 and the receiving antenna of the communication device 2 and the connection between the receiving antenna of the communication device 1 and the transmitting antenna of the communication device 2. For example, in FIG. 19A, it is necessary to separately perform the round-robin trainings between antenna setting candidates of the transmitting antenna of the communication device 1 and the receiving antenna of the communication device 2 (S602 to S607) and the round-robin trainings between antenna setting candidates of the receiving antenna of the communication device 1 and the transmitting antenna of the communication device 2 (S608 to S613).

However, when each of the transceivers 400 and 500 has only one antenna array and the one antenna array is used for both the transmission and the reception by switching or by using a similar scheme, the workload of the procedure described in the first to fifth exemplary embodiments is reduced to about the half. Because it can be considered that the transmitting-antenna setting candidates (transmission beam direction) of the transceiver 400 are the same as its own receiving-antenna setting candidates (reception beam direction). This also holds true for the transmitting-antenna setting candidates (transmission beam direction) and the receiving-antenna setting candidates (reception beam direction) of the transceiver 500. For example, only one of the steps S602 to S607 and steps S608 to S613 in FIG. 19A may be performed. In this case, since only one antenna-setting pair list is necessary, the determination of an antenna-setting pair(s) caused by a side-lobe (S614) and the update of the antenna-setting pair list (S615) shown in FIG. 19B may be performed in only one of the communication devices.

Further, even when each of the transceivers 400 and 500 has both the transmitting antenna and the receiving antenna, the workload of the procedure described in the first to fifth exemplary embodiments can be reduced to about the half in a similar manner to the above-described manner when the distance between the transmitting antenna and the receiving antenna of each communication device is sufficiently small in comparison to the length of the propagation path and the configurations of the transmitting antenna and the receiving antenna of each communication device are identical to each other.

Incidentally, the term “communication quality” has been used in the above-described first to twelfth exemplary embodiments. The communication quality may be any value representing communication quality such as a received-signal level, a signal to noise ratio (SNR), a bit error rate (BER), a packet error rate (PER), and a frame error rate (PER), and one or more than one of them may be used. Further, a certain data string in a preamble contained in a transmission data string of the transmitter 401 or transmitter 501 may be used for the communication quality evaluation.

Further, controls and arithmetic operations for the generating and switching of antenna setting candidates that are performed in the transceivers 400 and 500 in the above-described first to fifth exemplary embodiments can be implemented by using a computer, such as a microprocessor(s), to execute a program(s) for transceiver. For example, in the case of the first exemplary embodiment, these operations may be implemented by causing a computer running a transmission/reception control program to execute the steps of calculations and transmission/reception controls shown in the sequence diagram in FIGS. 19A and 19B and FIG. 20. Similarly, controls and arithmetic operations for the generating and switching of antenna setting candidates that are performed in the transceiver 500 in the above-described first to fifth exemplary embodiments can be also implemented by using a computer, such as a microprocessor(s), to execute a program(s) for transceiver. For example, in the case of the first exemplary embodiment, these operations may be implemented by causing a computer running a transmission/reception control program to execute the steps of calculations and transmission/reception controls shown in the sequence diagram in FIGS. 19A and 19B and FIG. 20.

Further, in addition to the process/arithmetic circuits 406 and 506, part of the transmitter circuits 403 and 503 (modulation and the like), part of the receiver circuits 409 and 509 (demodulation and the like), and components relating to digital signal processing or device control of the control circuits 407 and 507 and the like may be implemented by causing a computer(s) such as a micro computer(s) or a DSP(s) (Digital Signal Processor(s)) to execute a program. The above-described program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Further, the so-called “software-antenna technology” may be applied to the transceivers 400 and 500. Specifically, the antenna setting circuits 404, 410, 504 and 510 may be constructed by digital filters, or a computer(s) such as a DSP(s).

In the above explanation, situations where communication is performed between two transceivers are explained as examples. However, the present invention is applicable to other situations where three or more transceivers perform communication.

Further, the present invention is not limited to the above-described exemplary embodiments, and needless to say, various modifications can be made without departing from the spirit and scope of the present invention described above.

For example, the whole or part of the exemplary embodiments disclosed above can be described as, but not limited to, the following supplementary notes.

### (Supplementary Note 1)

A control method of a radio communication system including first and second communication devices, in which

the first communication device is configured to control a transmission beam direction of a first transmitting antenna by changing a transmitting-antenna setting and to control a reception beam direction of a first receiving antenna by changing a receiving-antenna setting,

the second communication device is configured to control a transmission beam direction of a second transmitting antenna by changing a transmitting-antenna setting and to control a reception beam direction of a second receiving antenna by changing a receiving-antenna setting, and

the method includes:

(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;

(b) obtaining a data string describing a relation of communication qualities of the second receiving antenna for the at least a part of combinations based on reception results of the training signal obtained in the step (a);

(c) arranging, in the data string, the combinations of the antenna settings in descending order of communication quality;

(d) updating, in the arranged data string, the data string in regard to combinations of antenna settings having the same antenna setting for one of the transmitting and receiving antennas;

(e) obtaining a similar data string by performing the same steps as the steps (a) to (d), which were performed by using the first transmitting antenna and the second receiving antenna, for at least a part of possible combinations of antenna settings of the second transmitting antenna and the first receiving antenna; and

(f) using, for communication between the first and second communication devices, at least a part of the combinations of the first-transmitting-antenna setting and the second-receiving-antenna setting and the combinations of the first-receiving-antenna setting and the second-transmitting-antenna setting described in the data strings obtained in the steps (d) and (e).

### (Supplementary Note 2)

The control method of a radio communication system described in Supplementary note 1, in which the updating the data string in the step (d) includes deleting, from the data string, a combination for which communication quality is ranked in a second or lower place among combinations of antenna settings having the same antenna setting for one of the transmitting and receiving antennas in the arranged data string.

### (Supplementary Note 3)

The control method of a radio communication system described in Supplementary note 1, in which the updating the data string in the step (d) includes lowering, in the data string, a priority rank of a combination for which communication quality is ranked in a second or lower place among combinations of antenna settings having the same antenna setting for one of the transmitting and receiving antennas in the arranged data string.

### (Supplementary Note 4)

The control method of a radio communication system described in any one of Supplementary notes 1 to 3, in which the step (f) includes performing radio communication by using a combination of antenna setting candidates that is successively selected according to rank in the data string.

### (Supplementary Note 5)

The control method of a radio communication system described in Supplementary note 4, in which the step (f) includes monitoring communication quality during communication, selecting a combination of antenna settings ranked in a next place according to the priority rank in response to deterioration of the communication quality during the communication, and performing radio communication by using the selected combination of antenna settings.

### (Supplementary Note 6)

The control method of a radio communication system described in any one of Supplementary notes 1 to 5, in which antenna settings used in the step (a) and a step in the step (e) corresponding to the step (a) are obtained by:

(a1) transmitting a training signal from the first transmitting antenna while changing the antenna setting of the first transmitting antenna;

(a2) receiving the training signal by the second receiving antenna in a state where a fixed beam pattern is set in the second receiving antenna;

(a3) obtaining a data string describing a relation between antenna setting of the first transmitting antenna and a reception signal characteristic of the second receiving antenna based on a reception result of a training signal obtained in the step (a2);

(a4) determining, by using the data string, at least one first transmitting-antenna setting, which each serves as a candidate to be used for communication, of the first transmitting antenna;

(a5) determining at least one second transmitting-antenna setting, which each serves as a candidate to be used for communication, of the second transmitting antenna, by performing the same steps as the steps (a1) to (a4), which were performed by using the first transmitting antenna and the second receiving antenna, for a combination of the second transmitting antenna and the first receiving antenna;

(a6) transmitting a training signal from the first transmitting antenna in a state where a fixed beam pattern is set in the first transmitting antenna;

(a7) receiving the training signal by the second receiving antenna while changing the antenna setting of the second receiving antenna;

(a8) obtaining a data string describing a relation between antenna setting and a reception signal characteristic of the second receiving antenna based on a reception result of a training signal obtained in the step (a7);

(a9) determining at least one second receiving-antenna setting, which each serves as a candidate to be used for communication, of the second receiving antenna by using the data string; and

(a10) determining at least one first receiving-antenna setting, which each serves as a candidate to be used for communication, of the first receiving antenna, by performing the same steps as the steps (a6) to (a9), which were performed by using the first transmitting antenna and the second receiving antenna, for a combination of the second transmitting antenna and the first receiving antenna.

### (Supplementary Note 7)

The control method of a radio communication system described in Supplementary note 6, in which the fixed beam pattern is an omni (nondirectional) pattern or a quasi-omni (quasi-nondirectional) pattern.

### (Supplementary Note 8)

A radio communication system including:

a first communication device configured to transmit a radio signal from a first transmitting antenna and to receive a radio signal by a first receiving antenna;

a second communication device is configured to transmit a radio signal from a second transmitting antenna and to receive a radio signal by a second receiving antenna;

first means for transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;

second means for obtaining a data string describing a relation of communication qualities of the second receiving antenna for the at least a part of combinations based on reception results of the training signal obtained by the first means;

third means for arranging, in the data string, the combinations of the antenna settings in descending order of communication quality;

fourth means for updating, in the arranged data string, the data string in regard to combinations of antenna settings having the same antenna setting for one of the transmitting and receiving antennas;

fifth means for obtaining a similar data string by performing the same operations as the first to fourth means, which were performed by using the first transmitting antenna and the second receiving antenna, for at least a part of possible combinations of antenna settings of the second transmitting antenna and the first receiving antenna; and

sixth means for using, for communication between the first and second communication devices, at least a part of the combinations of the first-transmitting-antenna setting and the second-receiving-antenna setting and the combinations of the first-receiving-antenna setting and the second-transmitting-antenna setting described in the data strings obtained by the fourth and fifth means.

### (Supplementary Note 9)

The radio communication system described in Supplementary note 8, in which the update of the data string by the fourth means is performed by deleting, from the data string, a combination whose reception signal characteristic is in a second or lower place among combinations of antenna settings having the same antenna setting for one of the transmitting and receiving antennas in the arranged data string.

### (Supplementary Note 10)

The radio communication system described in Supplementary note 8, in which the update of the data string by the fourth means is performed by lowering, in the data string, a priority rank of a combination whose reception signal characteristic is in a second or lower place among combinations of antenna settings having the same antenna setting for one of the transmitting and receiving antennas in the arranged data string.

### (Supplementary Note 11)

The radio communication system described in any one of Supplementary notes 8 to 10, in which the sixth means performs radio communication by using a combination of antenna setting candidates that is successively selected according to rank in the data string.

### (Supplementary Note 12)

The radio communication system described in Supplementary note 11, in which the sixth means monitors communication quality during communication, selects a combination of antenna settings ranked in a next place according to the priority rank in response to deterioration of the communication quality, and performing radio communication by using the selected combination of antenna settings.

### (Supplementary Note 13)

The radio communication system described in any one of Supplementary notes 8 to 12, in which antenna settings used in the first means and a step by the fifth means corresponding to the first means are obtained by:

(a1) transmitting a training signal from the first transmitting antenna while changing the antenna setting of the first transmitting antenna;

(a2) receiving the training signal by the second receiving antenna in a state where a fixed beam pattern is set in the second receiving antenna;

(a3) obtaining a data string describing a relation between antenna setting of the first transmitting antenna and a reception signal characteristic of the second receiving antenna based on a reception result of a training signal obtained in the step (a2);

(a4) determining, by using the data string, at least one first transmitting-antenna setting, which each serves as a candidate to be used for communication, of the first transmitting antenna by using the data string;

(a5) determining at least one second transmitting-antenna setting, which each serves as a candidate to be used for communication, of the second transmitting antenna, by performing the same steps as the steps (a1) to (a4), which were performed by using the first transmitting antenna and the second receiving antenna, for a combination of the second transmitting antenna and the first receiving antenna;

(a6) transmitting a training signal from the first transmitting antenna in a state where a fixed beam pattern is set in the first transmitting antenna;

(a7) receiving the training signal by the second receiving antenna while changing the antenna setting of the second receiving antenna;

(a8) obtaining a data string describing a relation between antenna setting and a reception signal characteristic of the second receiving antenna based on a reception result of a training signal obtained in the step (a7);

(a9) determining at least one second receiving-antenna setting, which each serves as a candidate to be used for communication, of the second receiving antenna by using the data string; and

(a10) determining at least one first receiving-antenna setting, which each serves as a candidate to be used for communication, of the first receiving antenna, by performing the same steps as the steps (a6) to (a9), which were performed by using the first transmitting antenna and the second receiving antenna, for a combination of the second transmitting antenna and the first receiving antenna.

### (Supplementary Note 14)

The radio communication system described in Supplementary note 13, in which the fixed beam pattern is an omni (nondirectional) pattern or a quasi-omni (quasi-nondirectional) pattern.

### (Supplementary Note 15)

A control method of a radio communication system including first and second communication devices, in which

the first communication device is configured to control a transmission beam direction of a first transmitting antenna by changing a transmitting-antenna setting and to control a reception beam direction of a first receiving antenna by changing a receiving-antenna setting,

the second communication device is configured to control a transmission beam direction of a second transmitting antenna by changing a transmitting-antenna setting and to control a reception beam direction of a second receiving antenna by changing a receiving-antenna setting, and

the method includes:

(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;

(b) obtaining communication qualities of the second receiving antenna for the at least a part of combinations based on reception results of the training signal obtained in the step (a);

(c) determining priority order among combinations included in the at least a part of combinations in such a manner that a priority rank of a combination of antenna settings for which the communication quality is good becomes relatively high, and a priority rank of a combination for which the communication quality is ranked in a second or lower place among combinations of antenna settings having the same antenna setting for one of the first transmitting antenna and second receiving antenna becomes relatively low;

(d) obtaining similar priority order by performing the same steps as the steps (a) to (c), which were performed by using the first transmitting antenna and the second receiving antenna, for at least a part of possible combinations of antenna settings of the second transmitting antenna and the first receiving antenna; and

(e) determining a combination of antenna settings used for communication between the first and second communication devices based on the priority orders obtained in the steps (d) and (d),

### (Supplementary Note 16)

A radio communication apparatus that performs radio communication with a corresponding device, including:

a transmitting-antenna setting control unit that controls a transmission beam direction of a first transmitting antenna by changing a transmitting-antenna setting;

a receiving-antenna setting control unit that controls a reception beam direction of a first receiving antenna by changing a receiving-antenna setting; and

a processing unit that performs a process of determining priority order of combinations of antenna settings of the first transmitting antenna and a second receiving antenna of the corresponding device, and determining priority order of combinations of antenna settings of the first receiving antenna and a second transmitting antenna of the corresponding device in a cooperative manner with the corresponding device, in which

the determination process includes:

(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;

(b) obtaining communication qualities of the second receiving antenna for the at least a part of combinations based on reception results of the training signal obtained in the step (a);

(c) determining priority order among combinations included in the at least a part of combinations in such a manner that a priority rank of a combination of antenna settings for which the communication quality is good becomes relatively high, and a priority rank of a combination for which the communication quality is ranked in a second or lower place among combinations of antenna settings having the same antenna setting for one of the first transmitting antenna and second receiving antenna becomes relatively low;

(d) obtaining similar priority order by performing the same steps as the steps (a) to (c), which were performed by using the first transmitting antenna and the second receiving antenna, for at least a part of possible combinations of antenna settings of the second transmitting antenna and the first receiving antenna; and

(e) determining a combination of antenna settings used for communication between the first and second communication devices based on the priority orders obtained in the steps (d) and (d).

This application is based upon and claims the benefit of priority from Japanese patent application No. 2010-062568, filed on Mar. 18, 2010, the disclosure of which is incorporated herein in its entirety by reference.

### REFERENCE SIGNS LIST

400, 500 TRANSCEIVER
401, 801, 81, 91 TRANSMITTER
402, 502, 82, 92 RECEIVER
403, 503 TRANSMITTER CIRCUIT
404 ANTENNA SETTING CIRCUIT
404-1 to 404-M, 504-1 to 504-K AWV (ARRAY WEIGHT VECTOR) CONTROL CIRCUIT
405-1 to 405-M, 505-1 to 505-K TRANSMISSION RADIATING ELEMENT
406, 506 PROCESS/ARITHMETIC CIRCUIT
407, 507 CONTROL CIRCUIT
408, 508 STORAGE CIRCUIT
409, 509 RECEIVER CIRCUIT
410 ANTENNA SETTING CIRCUIT
410-1 to 410-N, 510-1 to 510-L AWV (ARRAY WEIGHT VECTOR) CONTROL CIRCUIT
411-1 to 411-N, 511-1 to 511-L RECEPTION RADIATING ELEMENT
413, 513 CONTROL CIRCUIT
414 ANTENNA SETTING CIRCUIT
414-1 to 214-M SWITCH
415-1 to 415-M TRANSMISSION RADIATING ELEMENT
416 ANTENNA SETTING CIRCUIT
416-1 to 416-N SWITCH
417-1 to 417-N RECEPTION RADIATING ELEMENT
83 BEAM PATTERN (IMAGE)
84, 85 REFLECTOR
86 HUMAN BODY
61 WALL
62 REFLECTOR

1. A control method of a radio communication system comprising first and second communication devices, wherein
the first communication device is configured to control a transmission beam direction of a first transmitting antenna by changing a transmitting-antenna setting and to control a reception beam direction of a first receiving antenna by changing a receiving-antenna setting,
the second communication device is configured to control a transmission beam direction of a second transmitting antenna by changing a transmitting-antenna setting and to control a reception beam direction of a second receiving antenna by changing a receiving-antenna setting, and
the method comprises;
(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;
(b) obtaining a data string describing a relation of communication qualities of the second receiving antenna for the at least a part of combinations based on reception results of the training signal obtained in the operation (a);
(c) arranging, in the data string, the combinations of the antenna settings in descending order of communication quality;
(d) updating, in the arranged data string, the data string in regard to combinations of antenna settings having the same antenna setting for one of the transmitting and receiving antennas;
(e) obtaining a similar data string by performing the same operations as the operations (a) to (d), which were performed by using the first transmitting antenna and the second receiving antenna, for at least a part of possible combinations of antenna settings of the second transmitting antenna and the first receiving antenna; and
(f) using, for communication between the first and second communication devices, at least a part of the combinations of the first-transmitting-antenna setting and the second-receiving-antenna setting and the combinations of the first-receiving-antenna setting and the second-transmitting-antenna setting described in the data strings obtained in the operations (d) and (e).

2. The control method of a radio communication system according to claim 1, wherein the updating the data string in the operation (d) includes deleting, from the data string, a combination for which communication quality is ranked in a second or lower place among combinations of antenna settings having the same antenna setting for one of the transmitting and receiving antennas in the arranged data string.

3. The control method of a radio communication system according to claim 1, wherein the updating the data string in the operation (d) includes lowering, in the data string, a priority rank of a combination for which communication quality is ranked in a second or lower place among combinations of antenna settings having the same antenna setting for one of the transmitting and receiving antennas in the arranged data string.

4. The control method of a radio communication system according to claim 1, wherein antenna settings used in the operation (a) and an operation in the operation (e) corresponding to the operation (a) are obtained by:
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal characteristic of the second receiving antenna based on a reception result of a training signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.

5. A radio communication system comprising:
a first communication device configured to transmit a radio signal from a first transmitting antenna and to receive a radio signal by a first receiving antenna; and
a second communication device is configured to transmit a radio signal from a second transmitting antenna and to receive a radio signal by a second receiving antenna, wherein
the first and second communication devices are further configured to perform a process of determining priority order of combinations of antenna settings of the first transmitting antenna and the second receiving antenna, and determining priority order of combinations of antenna settings of the first receiving antenna and the second transmitting antenna in a cooperative manner, the process includes:
(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;
(b) obtaining a data string describing a relation of communication qualities of the second receiving antenna for the at least a part of combinations based on reception results of the training signal obtained by the operation (a);
(c) arranging, in the data string, the combinations of the antenna settings in descending order of communication quality;
(d) updating, in the arranged data string, the data string in regard to combinations of antenna settings having the same antenna setting for one of the transmitting and receiving antennas;
(e) obtaining a similar data string by performing the same operations as the operations (a) to (d), which were performed by using the first transmitting antenna and the second receiving antenna, for at least a part of possible combinations of antenna settings of the second transmitting antenna and the first receiving antenna; and
(f) using, for communication between the first and second communication devices, at least a part of the combinations of the first-transmitting-antenna setting and the second-receiving-antenna setting and the combinations of the first-receiving-antenna setting and the second-transmitting-antenna setting described in the data strings obtained by the operations (d) and (e).

6. The radio communication system according to claim 5, wherein the updating the data string in the operation (d) includes deleting, from the data string, a combination whose reception signal characteristic is in a second or lower place among combinations of antenna settings having the same antenna setting for one of the transmitting and receiving antennas in the arranged data string.

7. The radio communication system according to claim 5, wherein updating the data string in the operation (d) includes lowering, in the data string, a priority rank of a combination whose reception signal characteristic is in a second or lower place among combinations of antenna settings having the same antenna setting for one of the transmitting and receiving antennas in the arranged data string.

8. The radio communication system according to claim 5, wherein antenna settings used in the operation (a) and an operation in the operation (e) corresponding to the operation (a) are obtained by
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal characteristic of the second receiving antenna based on a reception result of a training signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.

9. A control method of a radio communication system comprising first and second communication devices, wherein
the first communication device is configured to control a transmission beam direction of a first transmitting antenna by changing a transmitting-antenna setting and to control a reception beam direction of a first receiving antenna by changing a receiving-antenna setting,
the second communication device is configured to control a transmission beam direction of a second transmitting antenna by changing a transmitting-antenna setting and to control a reception beam direction of a second receiving antenna by changing a receiving-antenna setting, and
the method comprises:
(a) transmitting a training signal from the first transmitting antenna and receiving the training signal by the second receiving antenna while changing antenna settings of the first transmitting antenna and the second receiving antenna for at least a part of possible combinations of the antenna settings of the first transmitting antenna and the second receiving antenna;
(b) obtaining communication qualities of the second receiving antenna for the at least a part of combinations based on reception results of the training signal obtained in the operations (a);
(c) determining priority order among combinations included in the at least a part of combinations in such a manner that a priority rank of a combination of antenna settings for which the communication quality is good becomes relatively high, and a priority rank of a combination for which the communication quality is ranked in a second or lower place among combinations of antenna settings having the same antenna setting for one of the first transmitting antenna and second receiving antenna becomes relatively low;
(d) obtaining similar priority order by performing the same operations as the operations (a) to (c), which were performed by using the first transmitting antenna and the second receiving antenna, for at least a part of possible combinations of antenna settings of the second transmitting antenna and the first receiving antenna; and
(e) determining a combination of antenna settings used for communication between the first and second communication devices based on the priority orders obtained in the operations (c) and (d).

10. (canceled)

11. The control method of a radio communication system according to claim 1, wherein the using in the operation (f) includes performing radio communication by using a combination of antenna setting candidates that is successively selected according to rank in the data string.

12. The control method of a radio communication system according to claim 11, wherein the using in the operation (f) further includes monitoring communication quality during communication, selecting a combination of antenna settings ranked in a next place according to the priority rank in response to deterioration of the communication quality during the communication, and performing radio communication by using the selected combination of antenna settings.

13. The control method of a radio communication system according to claim 4, wherein the fixed beam pattern comprises an omni (nondirectional) pattern or a quasi-omni (quasi-nondirectional) pattern.

14. The radio communication system according to claim 5, wherein the using in the operation (f) includes performing radio communication by using a combination of antenna setting candidates that is successively selected according to rank in the data string.

15. The radio communication system according to claim 14, wherein the using in the operation (f) further includes monitoring communication quality during communication, selecting a combination of antenna settings ranked in a next place according to the priority rank in response to deterioration of the communication quality during the communication, and performing radio communication by using the selected combination of antenna settings.

16. The radio communication system according to claim 8, wherein the fixed beam pattern comprises an omni (nondirectional) pattern or a quasi-omni (quasi-nondirectional) pattern.

17. The control method of a radio communication system according to claim 2, wherein antenna settings used in the operation (a) and an operation in the operation (e) corresponding to the operation (a) are obtained by:
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.

18. The control method of a radio communication system according to claim 3, wherein antenna settings used in the operation (a) and an operation in the operation (e) corresponding to the operation (a) are obtained by:
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal characteristic of the second receiving antenna based on a reception result of a training signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.

19. The radio communication system according to claim 6, wherein antenna settings used in the operation (a) and an operation in the operation (e) corresponding to the operation (a) are obtained by
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal characteristic of the second receiving antenna based on a reception result of a training signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.

20. The radio communication system according to claim 7, wherein antenna settings used in the operation (a) and an operation in the operation (e) corresponding to the operation (a) are obtained by
(a1) transmitting a training signal from the first transmitting antenna while changing the antenna setting of the first transmitting antenna;
(a2) receiving the training signal by the second receiving antenna in a state where a fixed beam pattern is set in the second receiving antenna;
(a3) obtaining a data string describing a relation between antenna setting of the first transmitting antenna and a reception signal characteristic of the second receiving antenna based on a reception result of a training signal obtained in the operation (a2);
(a4) determining, by using the data string, at least one first transmitting-antenna setting, which each serves as a candidate to be used for communication, of the first transmitting antenna;
(a5) determining at least one second transmitting-antenna setting, which each serves as a candidate to be used for communication, of the second transmitting antenna, by performing the same operations as the operations (a1) to (a4), which were performed by using the first transmitting antenna and the second receiving antenna, for a combination of the second transmitting antenna and the first receiving antenna;
(a6) transmitting a training signal from the first transmitting antenna in a state where a fixed beam pattern is set in the first transmitting antenna;
(a7) receiving the training signal by the second receiving antenna while changing the antenna setting of the second receiving antenna;
(a8) obtaining a data string describing a relation between antenna setting and a reception signal characteristic of the second receiving antenna based on a reception result of a training signal obtained in the operation (a7);
(a9) determining at least one second receiving-antenna setting, which each serves as a candidate to be used for communication, of the second receiving antenna by using the data string; and
(a10) determining at least one first receiving-antenna setting, which each serves as a candidate to be used for communication, of the first receiving antenna, by performing the same operations as the operations (a6) to (a9), which were performed by using the first transmitting antenna and the second receiving antenna, for a combination of the second transmitting antenna and the first receiving antenna.
